(19) United States
(12) Patent Application Publication
(10) Pub. No.: US 2024/0404103 A1
(43) Pub. Date: Dec. 5, 2024

(54) ELECTRONIC DEVICE FOR DETECTING OBJECT, AND CONTROL METHOD THEREFOR

(71) Applicant: MINDFORGE CO., LTD., Seoul (KR)

(72) Inventors: Kwon LEE, Seoul (KR); Kyuyeol CHAE, Seoul (KR)

(21) Appl. No.: 18/836,597

(22) PCT Filed: Feb. 8, 2023
(86) PCT No.: PCT/KR2023/001868

§ 371 Date: Aug. 7, 2024

(30) Foreign Application Priority Data
Feb. 8, 2022 (KR) 10-2022-0016340
Feb. 8, 2022 (KR) 10-2022-0016343
Feb. 8, 2023 (KR) 10-2023-0017037
Feb. 8, 2023 (KR) 10-2023-0017044

(51) Int. Cl. G06T 7/73; G06T 7/20; G06V 10/774; G06V 10/96; G06V 20/58

(52) U.S. Cl. CPC G06T 7/73; G06T 7/20; G06V 10/774; G06V 10/96; G06V 20/58; G06T 2207/10016; G06T 2207/20081; G06T 2207/20084; G06T 2207/30252

(57) ABSTRACT

An object detection device is disclosed. The object detection device of the present disclosure comprises a memory and at least one processor operatively connected to the memory, wherein the at least one processor can acquire a video, identify, in the video, a region in which content is changed in real time and a region in which content is not changed in real time, acquire image information about the video, and merge the image information into the region in which content is not changed in real time.

### CROSS-REFERENCE TO RELATED APPLICATION(S)

This application is a U.S. National Stage application under 35 U.S.C. § 371 of an International application number PCT/KR2023/001868, filed on Feb. 8, 2023, which is based on and claims priority of a Korean patent application number 10-2022-0016340, filed on Feb. 8, 2022, in the Korean Intellectual Property Office, and of a Korean patent application number 10-2022-0016343, filed Feb. 8, 2022, in the Korean Intellectual Property Office, and of a Korean patent application number 10-2023-0017037, filed on Feb. 8, 2023, in the Korean Intellectual Property Office, and of a Korean patent application number 10-2023-0017044, filed on Feb. 8, 2023, in the Korean Intellectual Property Office, the disclosure of each of which is incorporated by reference herein in its entirety.

### TECHNICAL FIELD

Various embodiments of the disclosure relate to an electronic device for detecting an object and a method for controlling the same.

### BACKGROUND ART

As interest in self-driving cars and AI robots grows, technologies that enable autonomous driving of electronic devices, such as cars or AI robots, are attracting attention. In order for an electronic device to move on its own without user intervention, required are technology that recognizes the external environment of the electronic device, technology that integrates the recognized information to determine actions, such as acceleration, stopping, and turning, and determines the driving path, and technology that uses the determined information to control the movement of electronic devices.

For autonomous driving of movable electronic devices, technology to recognize the external environment of electronic devices is becoming increasingly important.

Technologies that recognize the external environment may be broadly classified into sensor-based recognition technologies and connection-based recognition technologies. Sensors mounted on an electronic device for autonomous driving include ultrasonic, camera, radar, and LiDAR. These sensors are mounted on the electronic device to recognize the external environment of the vehicle and terrain, alone or together with other sensors, and provide information to the electronic device.

### DETAILED DESCRIPTION OF THE INVENTION

### Technical Problem

Technology for recognizing the external environment may photograph the surroundings of the electronic device through the camera and detect objects in the photographed image as a rectangular windows (e.g., bounding boxes) through deep learning.

However, when the object is tilted within the photographed rectangular image, because the size of the rectangular window to surround the tilted object should be larger than the size of the rectangular window to surround the object when the object is not tilted, the area where the object is not indeed positioned is also included in the window, leading to the object being misrecognized as being positioned.

To accurately extract objects within an image, semantic segmentation may be applied to classify the objects by classifying all of the pixels of the image but, in this case, real-time processing is difficult due to a large amount of computation, making it unsuitable for autonomous driving.

The disclosure provides an electronic device and a method for controlling the same for more accurately recognizing the area where an object is positioned in an image while minimizing the increase in computation amount.

### Technical Solution

According to various embodiments, an object detection device may comprise memory, at least one processor operatively connected to the memory. The at least one processor may obtain a moving image, identify an area where content changes in real time and an area where the content does not change in real time, as included in the moving image, obtain image information about the moving image, and merge the image information into the area where the content does not change in real time.

According to an embodiment, in a non-transitory computer-readable recording medium storing one or more programs, the one or more programs may comprise instructions that, when executed by a processor of an object detection device, enable the processor to: obtain a moving image, identify an area where content changes in real time and an area where the content does not change in real time, as included in the moving image, obtain image information about the moving image, and merge the image information into the area where the content does not change in real time.

### Advantageous Effects

An electronic device according to various embodiments of the disclosure may more accurately detect an area where an object is positioned in an image through a polygonal window having five or more angles while minimizing an increase in the amount of computation. Accordingly, it is possible to accurately recognize whether an object is positioned on the traveling path of the electronic device, and the autonomous driving performance of the electronic device may be enhanced.

The electronic device according to various embodiments of the disclosure may more accurately measure the distance between the electronic device and the object by predicting a hidden portion of the object in the image and measuring the distance to the object.

An electronic device according to various embodiments of the disclosure may store last depth information obtained during previous driving and use the stored depth information as initial depth information when starting is turned on thereafter, thereby enhancing accuracy of surrounding depth information obtained when restarting is performed while stopping.

An electronic device according to various embodiments of the disclosure may write and transmit image recognition information in a meaningless area (e.g., a blank area, a housing area, or a bumper area) of an image, thereby reducing resources further consumed when transmitting each of the image and the recognition information and enhancing the transmission speed.

### BRIEF DESCRIPTION OF THE DRAWINGS

FIG. 1 is a block diagram illustrating an example of a configuration of an electronic device according to various embodiments;

FIG. 2A is a view illustrating a brief configuration of an object detection device according to various embodiments;

FIG. 2B is a view illustrating a configuration of a camera module according to various embodiments;

FIG. 2C is a view illustrating a configuration of a camera module according to various embodiments;

FIG. 3 is a view illustrating an artificial intelligence model for recognizing an object included in an image according to various embodiments;

FIG. 4 is a flowchart illustrating an object detection operation of an object detection device according to various embodiments;

FIG. 5 is a view illustrating an embodiment of training data for training the artificial intelligence model of FIG. 3;

FIG. 6A is a view illustrating an embodiment of an operation of obtaining a polygonal window of training data;

FIG. 6B is a view illustrating an embodiment of output data output from the artificial intelligence model of FIG. 3;

FIG. 7A is a view illustrating an embodiment of an operation of obtaining a polygonal window of training data;

FIG. 7B is a view illustrating an embodiment of output data output from the artificial intelligence model of FIG. 3;

FIG. 8 is a view illustrating an example of applying a polygonal window according to the disclosure;

FIG. 9A is a view illustrating an example of applying a polygonal window according to the disclosure;

FIG. 9B is a view illustrating an example of applying a polygonal window according to the disclosure;

FIG. 9C is a view illustrating an example of applying a polygonal window according to the disclosure;

FIG. 10 is a view illustrating an artificial intelligence model for obtaining a position of contact with a ground of an object included in an image according to various embodiments;

FIG. 11 is a flowchart illustrating an object detection operation of an object detection device according to various embodiments;

FIG. 12 is a view illustrating an embodiment of training data for training the artificial intelligence model of FIG. 10;

FIG. 13A is a view illustrating training data when an object is not hidden according to various embodiments;

FIG. 13B is a view illustrating training data when a portion of an object is hidden according to various embodiments;

FIG. 14A is a view illustrating a distance measurement operation of an electronic device when an object is not hidden according to various embodiments;

FIG. 14B is a view illustrating a conventional distance measurement operation of an electronic device when an object is hidden according to various embodiments;

FIG. 14C is a view illustrating a distance measurement operation, according to the disclosure, of an electronic device when an object is hidden according to various embodiments;

FIG. 15A is a view illustrating an operation of measuring a distance to an object through a camera and patterned light by an electronic device according to various embodiments;

FIG. 15B is a view illustrating an image obtained by the operation of FIG. 15A;

FIG. 16 is a flowchart illustrating an operation of obtaining depth information by an electronic device according to various embodiments;

FIG. 17 is a flowchart illustrating an embodiment in which an object detection device included in an electronic device performs an object recognition operation according to various embodiments;

FIG. 18 is a flowchart illustrating an embodiment in which an electronic device performs an object recognition operation according to various embodiments;

FIG. 19A is a view illustrating an operation in which an electronic device includes image information in an image frame according to various embodiments;

FIG. 19B is a view illustrating an operation of generating a blank area in an image according to various embodiments;

FIG. 19C is a view illustrating an operation of generating a blank area in an image according to various embodiments;

FIG. 19D is a view illustrating an operation of generating a blank area in an image according to various embodiments;

FIG. 20A is a view illustrating distance information of an image according to various embodiments;

FIG. 20B is a view illustrating drivable road information of an image according to various embodiments;

FIG. 20C is a view illustrating object information of an image according to various embodiments; and

FIG. 21 is a view illustrating a structure of an image frame including image information according to various embodiments.

### MODE FOR CARRYING OUT THE INVENTION

Electronic devices according to various embodiments of the disclosure may include, e.g., vehicles, robots, drones, portable communication devices, portable multimedia devices, cameras, or wearable devices. Further, electronic devices may be devices that are fixedly installed in a specific location, such as CCTVs, kiosks, or home network devices. According to an embodiment of the disclosure, the electronic devices are not limited to those described above.

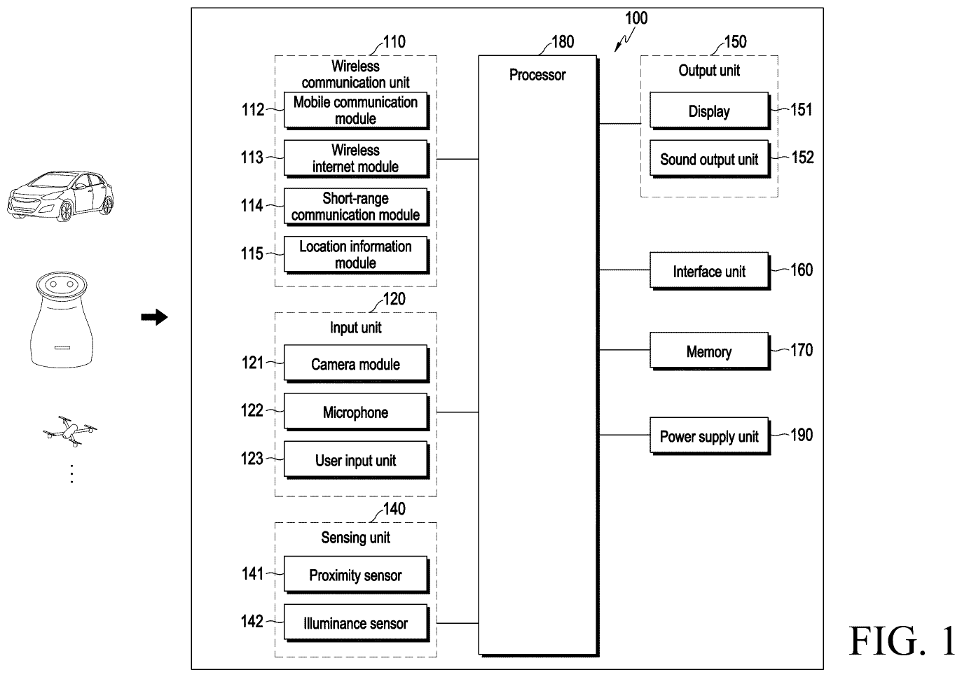

FIG. 1 is a block diagram illustrating an example of a configuration of an electronic device according to various embodiments.

Referring to FIG. 1, an electronic device 100 may include a wireless communication unit 110, an input unit 120, a sensing unit 140, an output unit 150, an interface unit 160, memory 170, a processor 180, and a power supply unit 190. The components shown in FIG. 1A are not necessary to implement the electronic device, and the electronic device described herein may have more or less components that those enumerated above.

The communication unit 110 may include one or more modules that enable wireless communication between the electronic device 100 and a wireless communication system, between the electronic device 100 and another device, or between the electronic device 100 and an external server. Further, the wireless communication unit 110 may include at least one of a mobile communication module 112, a wireless Internet module 113, a short-range communication module 114, and a location information module 115 to connect the electronic device 100 to one or more networks. The short-range communication module 114 may be intended for short-range communication and may support short-range communication using at least one of Bluetooth™M, radio frequency identification (RFID), infrared data association (IrDA), ultra-wideband (UWB), ZigBee, near-field communication (NFC), wireless-fidelity (Wi-Fi), Wi-Fi Direct, or wireless universal serial bus (USB) technology. The location information module 115 is a module for obtaining the location (or current location) of the electronic device and representative examples thereof include global positioning system (GPS) modules or wireless fidelity (Wi-Fi) modules.

The input unit 120 may include a camera module 121 or image input unit for inputting image signals, a microphone 122 or audio input unit for inputting audio signals, and a user input unit 123 (e.g., touch keys or mechanical keys) for receiving information from the user. The voice data or image data gathered by the input unit 120 may be analyzed and be processed by the user's control command. The input unit 120 may be one for inputting information from the user or image information (or signal), audio information (or signal), or data, and the electronic device 100 may include one or more camera modules 121. The camera module 121 processes image frames, such as still images or moving images, obtained by an image sensor in photograph mode. The processed image frames may be displayed on the display (e.g., the display 151 of FIG. 1) or be stored in the memory 170. The plurality of camera modules 121 provided in the electronic device 100 may be arranged to form a matrix structure, and a plurality of pieces of image information with various angles or foci may be input to the electronic device 100 via the camera modules 121 of the matrix structure. Further, the plurality of camera modules 121 may be arranged in a stereo structure to obtain a left image and right image for implementing a stereoscopic image.

The sensing unit 140 may include one or more sensors for sensing at least one of information in the electronic device 100, ambient environment information about the surroundings of the electronic device 100, and user information. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (e.g., a camera (refer to 121)), a microphone (refer to 122), a battery gauge, an environment sensor (e.g., a barometer, hygrometer, thermometer, radiation detection sensor, heat detection sensor, or gas detection sensor). Meanwhile, the electronic device of the disclosure may use a combination of pieces of information sensed by at least two or more sensors among the sensors.

The output unit 150 is intended to generate output related to visual, auditory, or tactile sense, and may include at least one of a display 151 and a sound output unit 152. The display 151 may be layered or integrated with a touch sensor, implementing a touchscreen. The touchscreen may function as the user input unit 123 to provide an input interface between the electronic device 100 and the user, as well as an output interface between the user and the electronic device 100.

The interface unit 160 plays a role as a pathway with various kinds of external devices connected to the electronic device 100. The interface unit 160 may include at least one of an external charger port, a wired/wireless data port, a memory card port, and a port for connecting a device equipped with an identification module. The electronic device 100 may perform proper control related to an external device in response to connection of the external device to the interface unit 160.

The memory 170 stores data supporting various functions of the electronic device 100. The memory 170 may also store a plurality of application programs (or applications) driven on the electronic device 100 and data and commands for operation of the electronic device 100. At least some of the application programs may be downloaded from an external server via wireless communication. Further, the electronic device 100 may come equipped with at least some of the application programs at the time of shipment for default functions of the electronic device 100. Meanwhile, the application program may be stored in the memory 170, installed on the electronic device 100, and driven by the processor 180 to perform an operation (or function) of the electronic device.

In addition to operations related to application programs, the processor 180 typically controls the overall operation of the electronic device 100. The processor 180 may be referred to as a controller 180. The processor 180 may process, e.g., signals, data, or information input or output via the above-described components or drive the application programs stored in the memory 170, thereby providing or processing information or functions suitable for the user. Further, the processor 180 may control at least some of the components described above in connection with FIG. 1 to drive the application programs stored in the memory 170. The processor 180 may operate two or more of the components of the electronic device 100, with at least two or more of the components combined together, so as to drive the application program.

The processor 180 may train the ANN based on the program stored in the memory 170. In particular, the processor 180 may train a neural network for recognizing data related to the electronic device 100. The neural network for recognizing the relevant data of the electronic device 100 may be designed to mimic the human brain on the computer and may include a plurality of weighted network nodes which mimic the neurons of the human neural network. The plurality of network nodes can send and receive data according to their respective connection relationships so as to simulate the synaptic activity of neurons that send and receive signals through synapses. Here, the neural network may include a deep learning model developed from the neural network model. In a deep learning model, a plurality of network nodes may be located in different layers and exchange data according to a convolutional connection relationship. Examples of neural network models include a deep neural network (DNN), a convolutional neural network (CNN), a recurrent neural network, a restricted Boltzmann machine, a deep belief network, a deep Q-Network, or such various deep learning schemes and may be applied in fields such as vision recognition, speech recognition, natural language processing, and voice/signal processing.

Meanwhile, the processor performing the above-described function may be a general-purpose processor (e.g., a central processing unit (CPU)), but may be an AI-dedicated processor (e.g., a graphics processing unit (GPU) and/or a neural processing unit (NPU)) for AI learning.

The processor 180 may train a neural network for data classification/recognition. The processor 180 may learn criteria regarding which training data is to be used to determine data classification/recognition and how to classify and recognize data using the training data. The processor 180 may obtain training data to be used for learning, and apply the obtained training data to the deep learning model to train the deep learning model.

The processor 180 may obtain training data necessary for a neural network model for classifying and recognizing data. For example, the processor 180 may obtain sensor data and/or sample data for input to the neural network model as training data.

The processor 180 may train the neural network model to have a determination criterion regarding how to classify predetermined data, using the obtained training data. In this case, the processor 180 may train the neural network model through supervised learning using at least some of the training data as a determination criterion. Alternatively, the processor 180 may train the neural network model through unsupervised learning for discovering a determination criterion by learning by itself using training data without guidance. Further, the processor 180 may train the neural network model through reinforcement learning using feedback on whether the result of determining the situation according to the learning is correct. The processor 180 may train the neural network model using a learning algorithm including an error back-propagation method or a gradient decent method.

When the neural network model is trained, the processor 180 may store the trained neural network model in the memory 170. The processor 180 may store the trained neural network model in the memory of a server connected to the electronic device 100 via a wired or wireless network.

The processor 180 may further include a training data preprocessing unit (not shown) and a training data selection unit (not shown) to enhance an analysis result of the recognition model or to save resources or time required to generate the recognition model. The training data preprocessing unit may preprocess the obtained data so that the obtained data may be used for learning for situation determination. For example, the training data preprocessing unit may process the obtained data into a preset format so that the processor 180 may use the obtained training data for learning for image recognition. Further, the training data selection unit may select data necessary for learning from the training data obtained by the processor 180 or the training data preprocessed by the preprocessing unit. The selected training data may be provided to the processor 180. For example, the training data selection unit may detect specific information among sensing information obtained through the sensor unit, and thus select only data on an object included in the specific information as training data.

Further, the processor 180 may input evaluation data to the neural network model to enhance the analysis result of the neural network model, and when the analysis result output from the evaluation data does not meet a predetermined criterion, the processor 180 may allow it to be retrained with the training data. In this case, the evaluation data may be predefined data for evaluating the recognition model. Further, in order to implement various embodiments described below on the electronic device 100 according to the disclosure, the processor 180 may control any one or more of the above-described components by combining the above-described components.

The power supply unit 190 receives external power or internal power to supplies power to each component included in the electronic device 100 under the control of the processor 180. The power supply unit 190 includes a battery, and the battery may be a built-in battery or a replaceable battery.

Various embodiments described herein may be implemented in a computer (or its similar device)-readable recording medium using software, hardware, or a combination thereof.

At least some of the components may cooperate with each other to implement the operation, control, or control method of the electronic device 100 according to various embodiments described below. Further, the operation, control, or control method of the electronic device 100 may be implemented by running at least one application program stored in the memory 170.

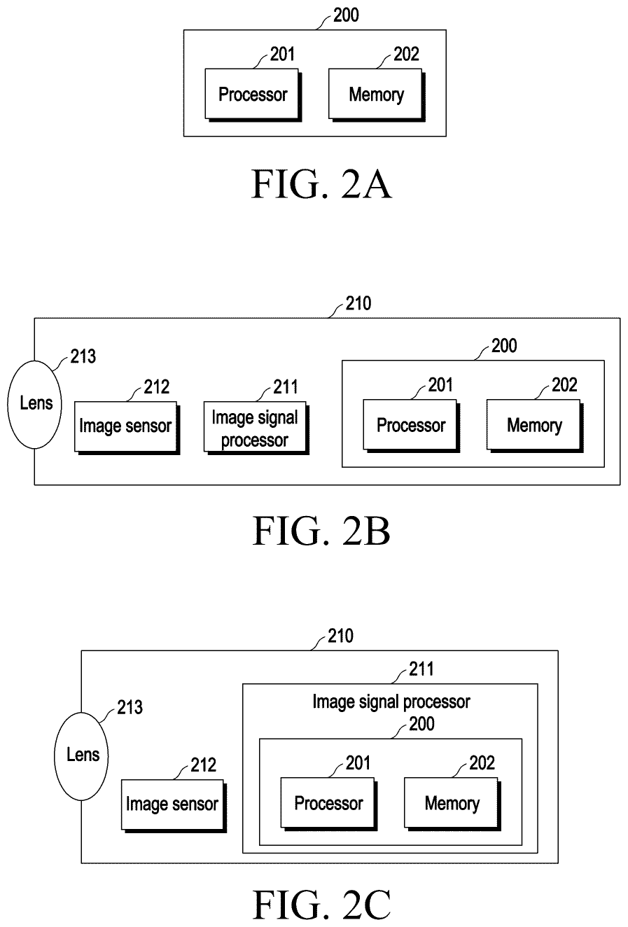

FIG. 2A is a view illustrating a configuration of an object detection device according to various embodiments.

Referring to FIG. 2A, an object detection device 200 may include a processor 201 and memory 202. According to an embodiment, the processor 201 and the memory 202 included in the object detection device 200 may be separate components from the processor 180 and the memory 170 of the electronic device 100. According to an embodiment, the processor 201 and the memory 202 included in the object detection device 200 may be the processor 180 and the memory 170, respectively, of the electronic device 100.

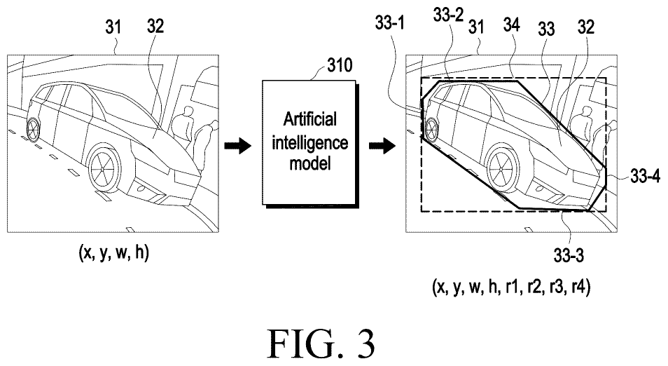

According to an embodiment, the processor 201 of the object detection device 200 may obtain an image and input the obtained image to an artificial intelligence model stored in the memory 202 to detect an object included in the image and/or obtain a distance to the object. According to an embodiment, an operation of training an artificial intelligence model, an operation of detecting an object using the trained artificial intelligence model, and an operation of obtaining a distance to the object are described with reference to FIGS. 3 to 16.

According to an embodiment, the processor 201 of the object detection device 200 may be included in a camera module (e.g., the camera module 121 of FIG. 1). Further, the object detection device 200 may be included in the camera module or may be configured as a module separate from the camera module.

According to an embodiment, at least some of the operations of the object detection device 200 to be disclosed through FIGS. 3 to 16 may be performed by a processor (e.g., the processor 180 of FIG. 1) and memory (e.g., the memory 170 of FIG. 1) of the electronic device 100.

FIGS. 2B and 2C are views illustrating a configuration of a camera module according to various embodiments.

Referring to FIG. 2B, the camera module 210 (e.g., the camera module 121 of FIG. 1) may include an object detection device 200, an image sensor 212, an image signal processor (ISP) 211, and a lens 213. Further, referring to FIG. 2C, the camera module 210 (e.g., the camera module 121 of FIG. 1) may include an image sensor 212, an image signal processor 211, and a lens 213, and the object detection device 200 may be included in the image signal processor 211.

The object detection device 200 may include a processor 201 and memory 202. The memory 202 stores an artificial intelligence model for detecting an object included in the image and/or obtaining a distance to the object.

The lens 213 may be formed of one lens or a combination of a plurality of lenses for collecting light. The camera module 210 may be, e.g., a wide-angle camera having an angle of view of 90 degrees or less or an ultra-wide-angle camera having an angle of view exceeding 90 degrees. The image sensor 212 may obtain an image corresponding to a subject by converting light transmitted through the lens 213 into an electrical signal. The image signal processor 211 may perform one or more image processing operations on an image obtained through the image sensor 212 or an image stored in a memory (e.g., the memory 170 of FIG. 1 or the memory 202 of FIGS. 2A to 2C). The one or more image processing operations may include, e.g., depth map generation, 3D modeling, panorama generation, feature point extraction, image synthesis, or image compensation (e.g., noise reduction, resolution adjustment, brightness adjustment, blurring, sharpening, or softening).

FIG. 3 is a view illustrating an artificial intelligence model for recognizing an object included in an image according to various embodiments.

Referring to FIG. 3, when an electronic device (e.g., the electronic device 100 of FIG. 1, the processor 180 of FIG. 1, the object detection device 200 or the processor 201 of FIGS. 2A to 2C) inputs an image 31 as input data to an artificial intelligence model 310 stored in memory (e.g., the memory 170 of FIG. 1 or the memory 202 of FIGS. 2A to 2C), it may obtain five or more parameters (e.g., x, y, w, h, r1, r2, r3, and r4) related to a polygonal window 33, of five or more angles, including an object 32 (e.g., a vehicle) included in the image 31. For example, x and y may be parameters related to the center coordinates of the rectangular window 34 overlapping the polygonal window 33, w may be a parameter related to the horizontal length of the rectangular window 34, and h may be a parameter related to the vertical length of the rectangular window 34.

According to various embodiments, the polygonal window 33 includes a plurality of sides 33-1, 33-2, 33-3, and 33-4 overlapping the rectangular window 34. For example, four sides 33-1, 33-2, 33-3, and 33-4 of the plurality of sides included in the polygonal window 33 are arranged parallel to the four sides of the rectangular window 34 and contact each other. For example, four of the six sides included in the hexagon may overlap the four sides, respectively, of one rectangle 34. For example, four of the eight sides included in the octagonal window 33 may overlap the four sides, respectively, of one rectangle 34.

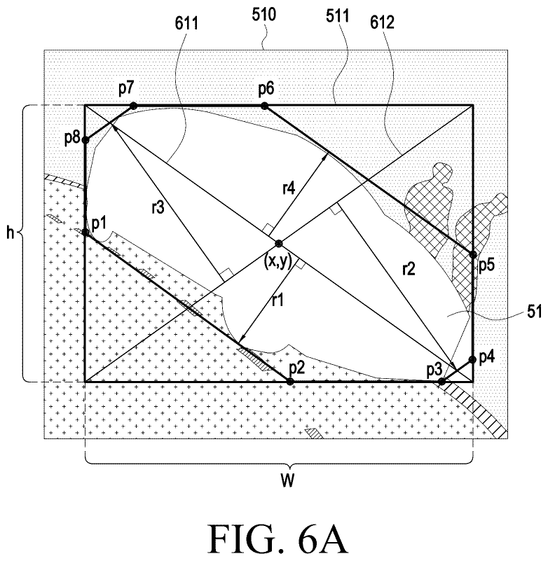

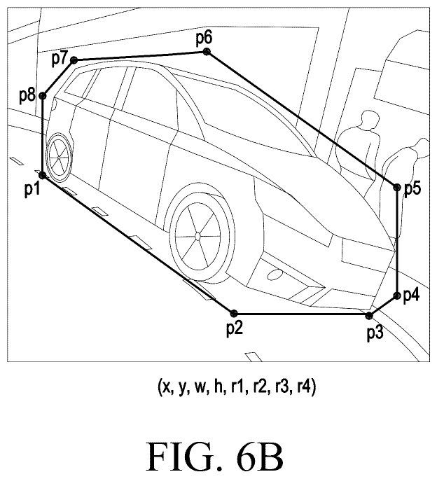

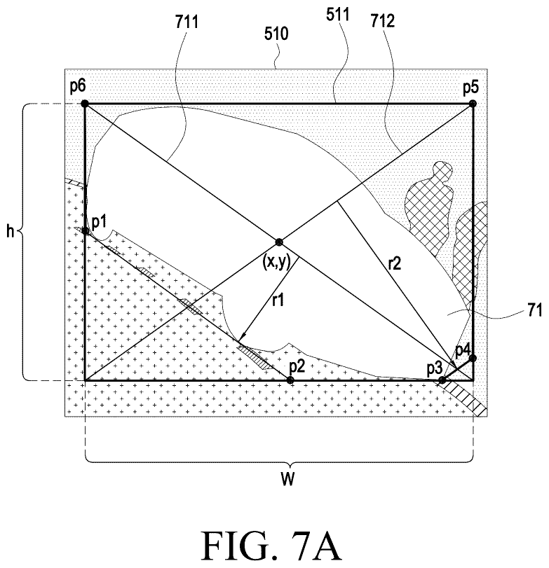

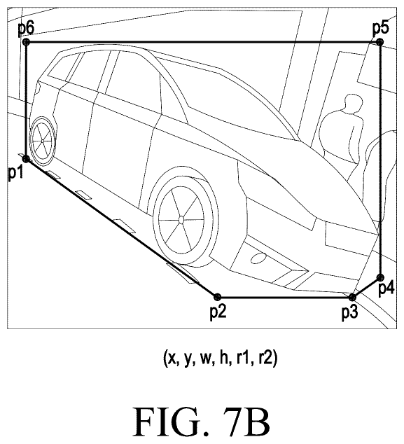

According to an embodiment, at least one of r1, r2, r3, and r4 may include at least one of first distance information between one of the two diagonal lines of the rectangular window 34 and the farthest point in a first direction toward the ground of the boundary of the object, second distance information to the farthest point in a second direction opposite to the first direction, third distance information between the other diagonal line and the farthest point in a third direction toward the ground of the boundary of the object, and fourth distance information to the farthest point in a fourth direction opposite to the third direction. According to an embodiment, the five or more parameters may be eight parameters (e.g., x, y, w, h, r1, r2, r3, r4) or six parameters (e.g., x, y, w, h, r1, r2). According to an embodiment, an operation of obtaining eight parameters is described with reference to FIGS. 6A and 6B, and an operation of obtaining six parameters is described with reference to FIGS. 7A and 7B.

According to an embodiment, the electronic device may obtain the farthest distance between the object and the boundary as a parameter based on two diagonal lines of the rectangular window 34, but the electronic device may obtain a parameter related to the distance between the object and the boundary based on at least one straight line connecting the perspective point (e.g., a vanishing point) of the image and at least one vertex farthest from the perspective point among the vertices of the rectangular window 32.

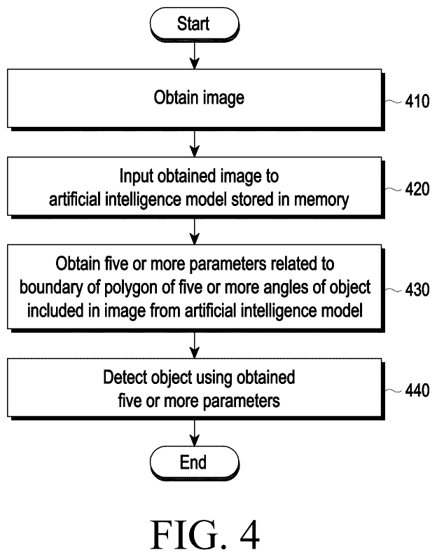

FIG. 4 is a flowchart illustrating an object detection operation of an object detection device according to various embodiments.

Referring to FIG. 4, in operation 410, the processor 201 of the object detection device 200 may obtain an image. For example, when the object detection device 200 is a device separate from a camera (e.g., the camera module 121 of FIG. 1 or the camera module 210 of FIGS. 2B to 2C) that captures an image, an image may be obtained from an external camera.

According to an embodiment, when the processor 201 is included in a camera (e.g., the camera module 121 of FIG. 1 or the camera module 210 of FIGS. 2B to 2C), the object detection device 200 may obtain an image from a lens and an image sensor included in the camera.

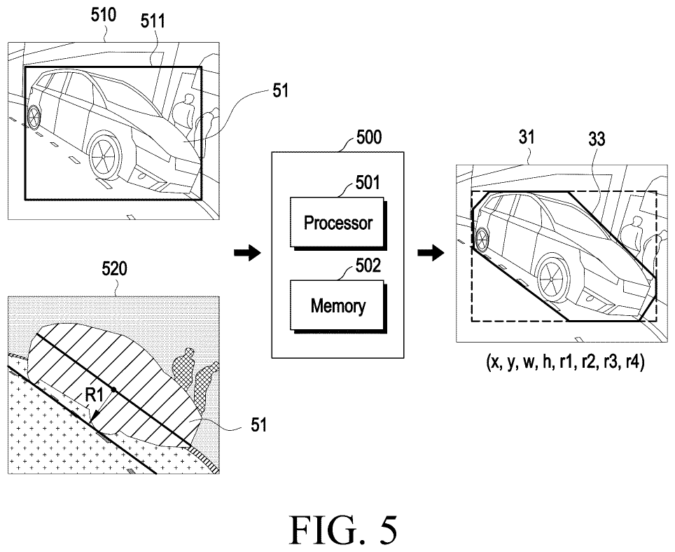

According to an embodiment, in operation 420, the processor 201 may input the obtained image to an artificial intelligence model stored in memory (e.g., the memory 170 of FIG. 1 or the memory 202 of FIGS. 2A to 2C). According to an embodiment, the artificial intelligence model may be trained to obtain, as output data, five or more parameters related to a polygonal window, of five or more angles, including an object included in the input image. According to an embodiment, the artificial intelligence model may be trained using a learning image and five or more parameters related to an object included in the learning image as training data. For example, the artificial intelligence model may be trained using a learning image and six or eight parameters related to an object included in the learning image as training data. According to an embodiment, the five or more parameters may be obtained based on information about a rectangular window surrounding an object included in the learning image and semantic segmentation information corresponding to the learning image. According to an embodiment, training data input to train an artificial intelligence model is described below with reference to FIG. 5.

According to an embodiment, in operation 430, the processor 201 may obtain, from the artificial intelligence model, five or more parameters related to a boundary of a polygon of five or more angles of an object included in the image. For example, the processor 201 may obtain six or eight parameters related to the hexagonal or octagonal boundary of the object included in the image from the artificial intelligence model.

According to an embodiment, the artificial intelligence model may be trained with eight parameters related to an octagonal window including an object included in the learning image as training data. According to an embodiment, the eight parameters may be obtained based on information about a rectangular window surrounding an object included in the learning image and semantic segmentation information corresponding to the learning image. The eight parameters may include position information about the center point of the rectangular window surrounding the object included in the learning image, horizontal length information, vertical length information, first distance information between one of two diagonal lines of the rectangular window and the point farthest in the first direction of the boundary of the object, second distance information to the point farthest in the second direction opposite to the first direction, third distance information between the other diagonal line and the point farthest in the third direction of the boundary of the object, and fourth distance information to the point farthest in the fourth direction opposite to the third direction. According to an embodiment, eight parameters input as training data and an octagonal window output from an artificial intelligence model are described below with reference to FIGS. 6A and 6B.

According to an embodiment, the artificial intelligence model may be trained with six parameters related to a hexagonal window including an object included in a learning image as the training data. According to an embodiment, the six parameters input as the training data may be obtained based on information about a rectangular window surrounding an object included in the learning image and semantic segmentation information corresponding to the learning image. The six parameters may include position information about a center point of a rectangular window surrounding an object included in the learning image, horizontal length information, vertical length information, first distance information between one of two diagonals of the rectangular window and a point farthest in a first direction toward the ground among boundaries of the object, and second distance information between another diagonal and a point farthest in a second direction toward the ground among boundaries of the object. According to an embodiment, six parameters input as training data and a hexagonal window output from an artificial intelligence model are described below with reference to FIGS. 7A and 7B.

According to an embodiment, the processor 201 of the object detection device 210 may obtain the farthest distance between the object and the boundary as a parameter based on two diagonal lines of the rectangular window, but the electronic device may obtain a parameter related to the distance between the object and the boundary based on at least one straight line connecting the perspective point (e.g., a vanishing point) of the image and at least one vertex farthest from the perspective point among the vertices of the rectangular window. According to an embodiment, the five or more parameters related to the polygonal window of five or more angles may include coordinate information about vertices of the polygonal window. According to an embodiment, when the artificial intelligence model is trained to output coordinate information about the vertex of the window, the output data of the artificial intelligence model may include coordinate information about the vertex of the polygonal window.

According to an embodiment, in operation 440, the processor 201 of the object detection device 210 may transfer the obtained five or more parameters to the processor (e.g., the processor 180 or the application processor) of the electronic device 100.

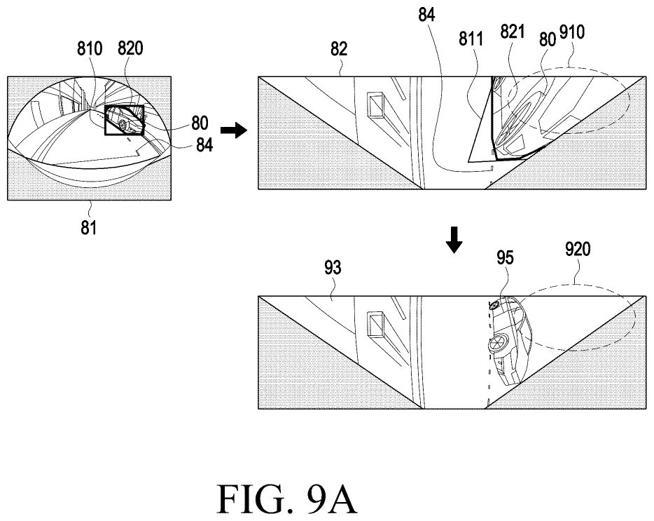

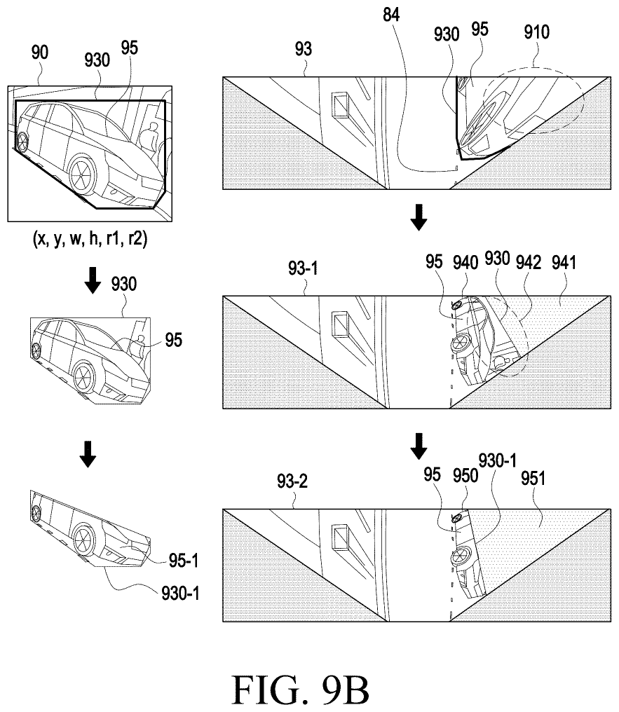

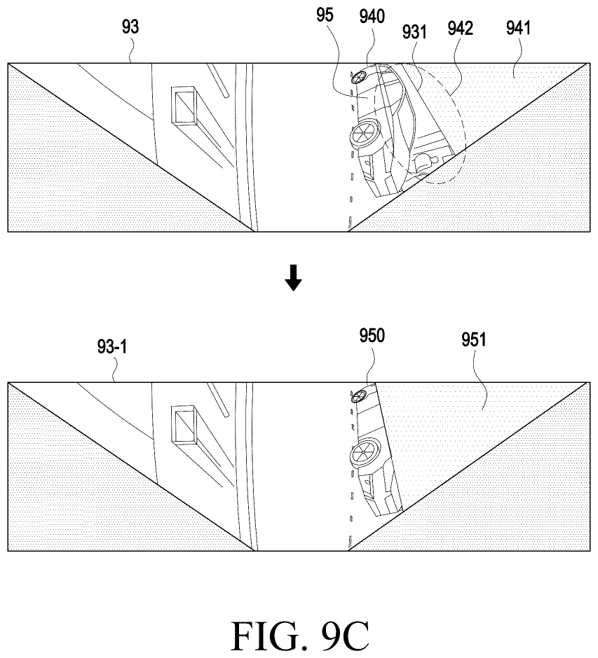

According to an embodiment, in operation 440, the processor 201 of the object detection device 210 may detect an object in the input image using the obtained five or more parameters. Further, the processor 201 of the object detection device 210 may control the polygonal window surrounding the object in the image to be displayed together while the obtained image is displayed on the display (e.g., the display 151 of FIG. 1). According to an embodiment, the processor 201 of the object detection device 210 may convert the obtained image into a birdeye view image and correct the distorted portion of the birdeye view image based on the image of the object included in the polygonal window. According to an embodiment, image conversion and correction operations are described below with reference to FIGS. 9A and 9B.

According to an embodiment, at least some of the above-described operations of the processor 201 of the object detection device 210 may be performed by the processor 180 of the electronic device (e.g., the electronic device 100 of FIG. 1). According to an embodiment, in operation 440, the processor 201 of the object detection device 210 may transfer the obtained five or more parameters to the processor 180 of the electronic device 100. Then, the processor 180 of the electronic device 100 may control the polygonal window surrounding the object in the image to be displayed together while the obtained image is displayed on the display (e.g., the display 151 of FIG. 1).

According to an embodiment, the processor 180 of the electronic device 100 may obtain an image from the camera module 121 provided in the electronic device 100, input the image to the artificial intelligence model stored in the memory 170 to obtain five or more parameters as output data, and correct the image converted into the birdeye view image using the obtained parameters.

FIG. 5 is a view illustrating an embodiment of training data for training the artificial intelligence model of FIG. 3.

Referring to FIG. 5, a training data generation device 500 may include a processor 501 and memory 502. The memory 502 stores a learning image 510, information about a rectangular window (e.g., a bounding box) 511 including an object, semantic segmentation information 520 corresponding to the learning image 510, and an artificial intelligence model. The processor 501 may generate labeling data for training based on the learning image 510, information about a rectangular window 511 including an object, semantic segmentation information 520 corresponding to the learning image 510. The labeling data for training includes five or more parameters related to the object included in the learning image. The information about the rectangular window 511 is annotation information about the rectangle including the learning object 51 (e.g., a vehicle), and may mean position information about the rectangle. The semantic segmentation information may refer to information obtained by classifying objects included in an image for each pixel.

According to an embodiment, the learning image 510, the parameter for the rectangular window 511, and the semantic segmentation information 520 input as the training data may be obtained from a disclosed database, or may be obtained by the user directly annotating the learning image 510. The information about the rectangular window 511 may be, e.g., four parameters indicating the rectangular window, and may be coordinates (x, y) of the center of the rectangular window, the horizontal length w and the vertical length h of the bounding box. Further, e.g., the four parameters indicating the rectangular window may be coordinates (x1, y1) of the upper left and coordinates (x2, y2) of the upper right of the rectangular window. Hereinafter, an example where the four parameters of the rectangular window are the coordinates (x, y) of the center of the rectangular window, the width w and the height h of the rectangle is described.

According to an embodiment, the semantic segmentation information 520 included in the training data may be obtained by dividing the object 51 included in the learning image 510 on a per-pixel basis. FIG. 6A is a view illustrating an embodiment of an operation of obtaining training data for a polygonal window.

FIG. 6B is a view illustrating an embodiment of output data output from the training data generation device 500 of FIG. 5.

Referring to FIG. 6A, the processor 501 of the training data generation device 500 may generate new labeling data for training using labeling data given from an existing public DB or labeling data produced by the user. For example, the processor 501 of the training data generation device 500 may obtain five or more (e.g., eight) parameters for the polygonal window surrounding the object 61 included in the learning image using the information about the rectangular window 511 and the semantic segmentation information 520, together with the learning image 510.

For example, as the parameters for the polygonal window, four parameters (e.g., x, y, w, h) for the rectangular window 510 in which the plurality of sides overlap the polygonal window, and four parameters related to the two diagonals 611 and 612 of the rectangular window 510 may be further obtained as training data. For example, the four parameters related to the two diagonal lines 611 and 612 may include first distance information r1 between the first diagonal line 611 connecting the upper left end and lower right end of the rectangular window 510 and the farthest point in the first direction toward the ground of the boundary of the object 51, second distance information r4 to the farthest point in the direction opposite to the first direction, third distance information r2 between the second diagonal line 612 connecting the upper right end and lower left end and the farthest point in the third direction toward the ground of the boundary of the object 51, and fourth distance information r3 to the farthest point in the direction opposite to the second direction.

According to an embodiment, the processor 501 of the training data generation device 500 may train the artificial intelligence model by inputting five or more parameters to the artificial intelligence model so that five or more parameters (e.g., six or eight) are obtained as output data of the artificial intelligence model. According to an embodiment, the processor 501 of the training data generation device 500 may obtain, from the learning image, a total of eight straight lines, e.g., four straight lines of the rectangular window 511, two straight lines parallel to the first diagonal line 611 and having distances r1 and r4 from the first diagonal line 611, two straight lines parallel to the second diagonal line 612 and having distances r2 and r3 from the second diagonal line 612, and may obtain eight parameters (x, y, w, h, r1, r2, r3, r4) for the octagonal window for the object 51 based on intersections (e.g., p1, p2, p3, p4, p5, p6, p7, and p8) of the eight straight lines.

According to an embodiment, the learning image and eight parameters (x, y, w, h, r1, r2, r3, and r4) may be input to the artificial intelligence model as training data, and the artificial intelligence model may be trained to output eight parameters for the object included in the input image.

Referring to FIG. 6B, the processor 501 of the training data generation device 500 may output an octagonal window having eight parameters (e.g., x, y, w, h, r1, r2, r3, and r4) and eight vertices (e.g., p1, p2, p3, p4, p5, p6, p7, and p8) as output data.

According to an embodiment, in FIG. 6A, parameters related to the distance information between the object boundary and the diagonal line are obtained based on two diagonal lines of the rectangular window, but the parameter related to the distance between the object and the boundary may be obtained based on the straight line connecting the perspective point (e.g., a vanishing point) of the learning image and the vertex farthest from the perspective point among the vertices of the rectangular window.

FIG. 7A is a view illustrating an embodiment of an operation of obtaining training data for a polygonal window.

FIG. 7B is a view illustrating an embodiment of output data output from the artificial intelligence model of FIG. 3.

Referring to FIG. 7A, the processor 501 of the training data generation device 500 may obtain five or more (e.g., six) parameters for the polygonal window surrounding the object 71 included in the learning image, using the learning image 510, the information about the rectangular window 511, and the semantic segmentation information.

For example, as the parameters for the polygonal window, four parameters (e.g., x, y, w, h) for the rectangular window 510 in which the plurality of sides overlap the polygonal window, and two parameters related to the two diagonals 711 and 712 of the rectangular window 510 may be further obtained as training data. For example, the two parameters related to the two diagonal lines 711 and 712 may include first distance information r1 between the first diagonal line 711 connecting the upper left end and the lower right end and the farthest point in a first direction (e.g., left vertically lower direction) toward the ground of the boundary of the object 71 and second distance information r2 between the second diagonal line 712 connecting the upper right end and lower left end and the farthest point in a second direction (e.g., right lower direction) toward the ground of the boundary of the object 71

According to an embodiment, the processor 501 of the training data generation device 500 may obtain, from the learning image, a total of six straight lines, e.g., four straight lines of the rectangular window 710, one straight line parallel to the first diagonal line 711 and having distance r1 from the first diagonal line 711, and one straight line parallel to the second diagonal line 712 and having distance r2 from the second diagonal line 712, and may obtain six parameters (x, y, w, h, r1, r2) for the hexagonal window for the object 71 based on intersections (e.g., p1, p2, p3, p4, p5, and p6) of the six straight lines.

According to an embodiment, the learning image and six parameters (x, y, w, h, r1, and r2) may be input to the artificial intelligence model as training data, and the artificial intelligence model may be trained to output six parameters for the object included in the input image.

Referring to FIG. 7B, the artificial intelligence model may output a hexagonal window having six parameters (e.g., x, y, w, h, r1, and r2) and six vertices (e.g., p1, p2, p3, p4, p5, and p6) as output data.

According to an embodiment, in FIG. 7A, parameters related to the distance information between the object boundary and the diagonal line are obtained based on two diagonal lines of the rectangular window, but the parameter related to the distance between the object and the boundary may be obtained based on the straight line connecting the perspective point (e.g., a vanishing point) of the learning image and the vertex farthest from the perspective point among the vertices of the rectangular window.

As such, as parameters are not obtained based on the diagonal lines for the portions (e.g., p5 and p6) not contacting the object and the ground, computation amount may be further reduced when the number of the parameters is six than when the number of the parameters is eight.

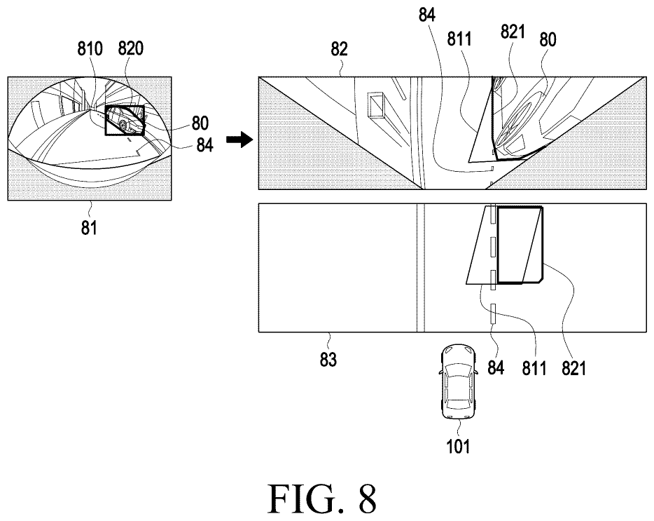

FIG. 8 is a view illustrating an example of an object detection method with a polygonal window applied according to the disclosure.

Referring to FIG. 8, the processor (e.g., the processor 180 of the electronic device of FIG. 1 or the processor 201 of the object detection device of FIGS. 2A to 2C) of the electronic device 100 may detect an object through a polygonal window 820 of five or more angles according to the disclosure in an image 81 obtained through a camera (e.g., the camera module 121 of FIG. 1 or the camera module 210 of FIGS. 2B to 2C). FIG. 8 illustrates an example of obtaining an image 81 using a camera attached to the rear of the vehicle 101 while the vehicle 101 with the electronic device 100 mounted in the vehicle 101 is actually driving on the road 83 or stops, and detecting an object 80 (e.g., vehicle) and a lane 84 in the image 81. For a comparative description, a rectangular window 810 including an object 80 and a polygonal window 820 are displayed together in the image 81 on the left side of FIG. 8. Further, on the right side of FIG. 8, a birdeye view image 82 and an actual road 83, which are viewed from the sky, are displayed. According to an embodiment, the processor (e.g., the processor 180 of the electronic device of FIG. 1 or the processor 201 of the object detection device of FIGS. 2A to 2C) of the electronic device 100 may obtain the image 81 through the camera while the mounted vehicle 101 is driving or stops, convert the obtained image 81 into the birdeye view image 82, and display the same on the display 151 for image (81) analysis. The conventional rectangular window 811 converted into the birdeye view may be displayed on the display 151 as crossing the lane 84 from right to left, but the polygonal window 812 having a pentagon or more according to the disclosure, converted into the birdeye view, may be displayed on the display 151 as not crossing the lane 84. Further, a processor (e.g., the processor 180 of the electronic device of FIG. 1 or the processor 201 of the object detection device of FIGS. 2A to 2C) of the electronic device 100 may recognize that the rectangular window 811 in the birdeye view image 82 actually crosses the lane 84 on the road 83, but the polygonal window 821 according to various embodiments of the disclosure may recognize that the rectangular window 811 does not cross the lane 84.

According to an embodiment, when the electronic device 100 uses the conventional object recognition technology, the electronic device 100 may recognize that the conventional rectangular window 812 converted into the birdeye view crosses the lane 84 on the road 83, and may misrecognize that the object 80 (e.g., a vehicle) is positioned on the traveling path of the electronic device 100. However, on the road 83, the electronic device 100 may recognize that the converted polygonal window of five or more angles 822 according to the disclosure does not cross the lane 84, and may recognize that the object 80 (e.g., a vehicle) is not positioned on the traveling path of the electronic device 100.

As described above, according to various embodiments of the disclosure, because training data is generated using a polygonal window for training an artificial intelligence model using the data generation device 500, there is no need for a task that consumes time and cost for a person to directly mark polygonal vertices on an object in a learning image for labeling the training data, and training data may be quickly generated using labeling information and semantic segmentation information about a rectangular window (e.g., a bounding box) provided from an existing disclosed DB.

Further, according to an embodiment of the disclosure, by using an artificial intelligence model trained with training data labeled with a polygonal window, the boundary of an object (e.g., another vehicle, bicycle, or person) on the path where the electronic device (e.g., a vehicle or a robot) travels may be accurately detected as compared with an artificial intelligence model trained only with a rectangular bounding box, so that the position of the object may be accurately determined. Further, an artificial intelligence model trained with training data labeled with a polygonal window may be trained by a light deep learning network as compared with an artificial intelligence model trained only with semantic segmentation information.

FIG. 9A is a view illustrating an example of an object detection method with a polygonal window applied according to the disclosure.

Referring to FIG. 9A, the processor (e.g., the processor 180 of the electronic device of FIG. 1 or the processor 201 of the object detection device of FIGS. 2A to 2C) of the electronic device 100 may recognize an object through a conventional rectangular window or through a polygonal window of five or more angles according to the disclosure in an image 81 obtained through a camera (e.g., the camera module 121 of FIG. 1 or the camera module 210 of FIGS. 2B to 2C). In FIG. 9A, a camera (e.g., the camera module 121 of FIG. 1 or the camera module 210 of FIGS. 2B to 2C) may be, e.g., a single wide-angle camera.

According to an embodiment, the processor (e.g., the processor 180 of the electronic device of FIG. 1 or the processor 201 of the object detection device of FIGS. 2A to 2C) of the electronic device 100 may convert the image 81 obtained through the camera into a birdeye view image 82. However, the converted birdeye view image 82 may be severely distorted 910 from the center to the boundary.

According to an embodiment, the processor (e.g., the processor 180 of the electronic device of FIG. 1 or the processor 201 of the object detection device of FIGS. 2A to 2C) of the electronic device 100 may correct the area including the distortion 910 in the birdeye view image 82. For example, when the image 81 obtained by the camera is converted into the birdeye view image 82, the electronic device may minimize distortion by differently applying a projection matrix to the detected polygonal window 820 or the detected object. According to an embodiment, the processor (e.g., the processor 180 of the electronic device of FIG. 1 or the processor 201 of the object detection device of FIGS. 2A to 2C) of the electronic device 100 may replace a partial area of the area 821 (e.g., the area including the distortion 910) corresponding to the polygonal window 820 in the birdeye view image 82 with the image 95 of the object included in the polygonal window 820 in the image 81 before converting the partial area into the birdeye view. According to an embodiment, the processor (e.g., the processor 180 of the electronic device of FIG. 1 or the processor 201 of the object detection device of FIGS. 2A to 2C) of the electronic device 100 may correct the remaining area 920 other than the area replaced by the object image 95 in the area 821 corresponding to the polygonal window 820 in the birdeye view image 82 into a blank area 920. According to an embodiment, the processor (e.g., the processor 180 of the electronic device of FIG. 1 or the processor 201 of the object detection device of FIGS. 2A to 2C) of the electronic device 100 may extract only the object 95 by dividing the object 95 included in the polygonal window 820 from surrounding pixels other than the object 95 and removing the surrounding pixels by applying a morphology operation.

The processor (e.g., the processor 180 of the electronic device of FIG. 1 or the processor 201 of the object detection device of FIGS. 2A to 2C) of the electronic device 100 may obtain the corrected birdeye view image 93 by controlling the object image 95 to be displayed in an area close to the center of the birdeye view image 82 and having relatively little distortion in the area 821 corresponding to the polygonal window 820, and the area far from the center of the birdeye view image 82 and having relatively much distortion to be set as the blank area 920. In the corrected birdeye view image 93, the blank area 920 may be displayed in a monochromatic color such as white or gray, instead of the distorted image 910.

FIGS. 9B and 9C are views illustrating an example of applying a polygonal window according to the disclosure.

Referring to FIGS. 9B and 9C, the processor (e.g., the processor 180 of the electronic device of FIG. 1 or the processor 201 of the object detection device of FIGS. 2A to 2C) of the electronic device 100 may recognize an object through a polygonal window 930 (e.g., a hexagon or an octagon) of five or more angles in an image obtained through a camera (e.g., the camera module 121 of FIG. 1 or the camera module 210 of FIGS. 2B to 2C). In FIGS. 9B and 9C, a hexagonal window 930 is described as an example.

Compared to the octagonal window 820 illustrated in FIG. 9A, the hexagonal window 930 may include more peripheral pixels other than the object 95 in the upper end portion of the hexagonal window 930. In this case, e.g., when it is intended to determine the distance between the electronic device 100 and the object 95, the electronic device 100 may sufficiently determine the distance even if only information about the lower end portion of the object 95 is obtained. Accordingly, according to an embodiment, after the upper end portion of the hexagonal window 930 is removed in proportion to the size information about the object, only the lower end portion 95-1 of the hexagonal window 930 may be displayed on the display 151. Accordingly, the lower end portion of the object 95 in the hexagonal window may be displayed on the display 151, and the upper end portion of the object 95 may not be displayed. According to an embodiment, the processor (e.g., the processor 180 of the electronic device of FIG. 1 or the processor 201 of the object detection device of FIGS. 2A to 2C) of the electronic device 100 may obtain the image of the lower end portion 95-1 of the object 95 in contact with the ground by obtaining the lower end portion 930-1 of the polygonal window 930 of the image 90 obtained through the camera. For example, when the area where the object is positioned in the image obtained through the camera is right from the center of the image, the lower portion of the diagonal line from the upper left portion 930-1 to the lower right portion 930-2 of the polygonal window 930 may be obtained as the partial image 932. According to an embodiment, when the area where the object is positioned in the image obtained through the camera is left from the center of the image, the lower portion of the diagonal line from the upper right end to the lower left end of the polygonal window 930 may be obtained as the partial image.

According to an embodiment, the processor (e.g., the processor 180 of the electronic device of FIG. 1 or the processor 201 of the object detection device of FIGS. 2A to 2C) of the electronic device 100 may convert the image obtained through the camera into a birdeye view image 93, and may obtain corrected images 93-1 and 93-2 obtained by correcting the distortion area 910 included in the birdeye view image 93.

According to an embodiment, the processor (e.g., the processor 180 of the electronic device of FIG. 1 or the processor 201 of the object detection device of FIGS. 2A to 2C) of the electronic device 100 may obtain the corrected image 93-1 by replacing the area (e.g., the area including distortion) corresponding to the polygonal window 930 in the birdeye view image 93 with the partial image 930 included in the polygonal window 95 in the image 90 before conversion. According to an embodiment, the processor (e.g., the processor 180 of the electronic device of FIG. 1 or the processor 201 of the object detection device of FIGS. 2A to 2C) of the electronic device 100 may correct an area other than the area 940, which is replaced with the partial image 930 included in the polygonal window 930 before conversion to the birdeye view, in the area corresponding to the polygonal window 930 in the birdeye view image 93 into a blank area 941. The blank area 941 may be displayed in a monochromatic color such as white or gray.

According to an embodiment, an unnecessary peripheral pixel area 942 other than the image 95 of the object may be included in the polygonal window 930. Meanwhile, e.g., in order for the electronic device to perform autonomous driving, autonomous driving is possible only by recognizing the lower end of the object (e.g., a vehicle, a person, an obstacle, etc.). Therefore, the processor (e.g., the processor 180 of the electronic device of FIG. 1 or the processor 201 of the object detection device of FIGS. 2A to 2C) of the electronic device 100 obtains a partial image 930-1 in contact with the ground in the image of the object included in the polygonal window 930 in the image 90 (e.g., the image obtained from the camera) before the birdeye view conversion, replaces the area 950 corresponding to the polygonal window 930 in the birdeye view image 93 with the partial image 930-1, and replaces the area corresponding to the polygonal window 930 in the birdeye view image 93 with the partial image 930-1, thereby obtaining the corrected image 93-2. The area 951 other than the replaced area 950 in the area corresponding to the polygonal window 930 may be corrected into the blank area 951. The blank area 951 may be displayed in a monochromatic color such as white or gray.

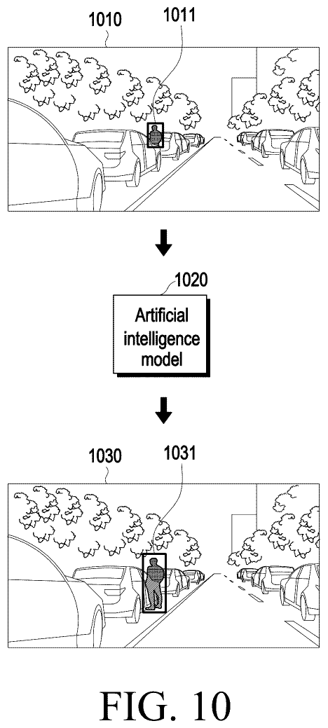

FIG. 10 is a view illustrating an artificial intelligence model for obtaining a position of contact with a ground of an object included in an image according to various embodiments.

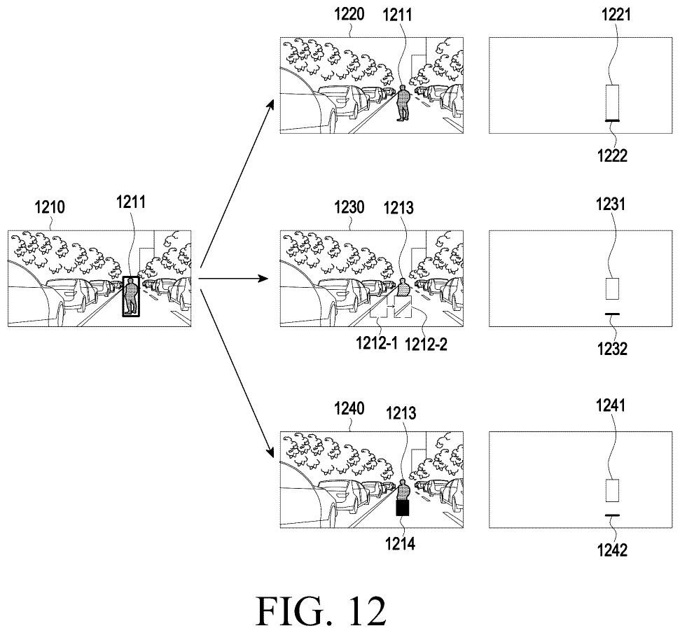

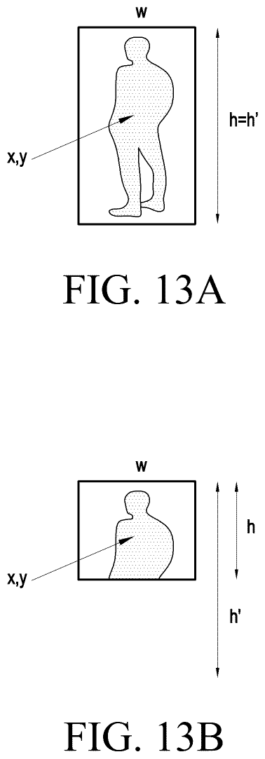

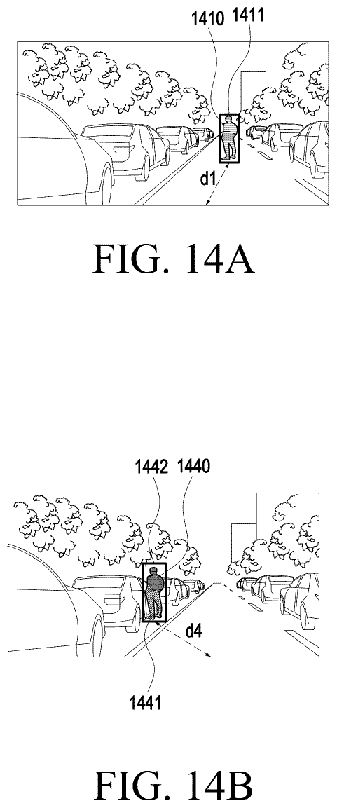

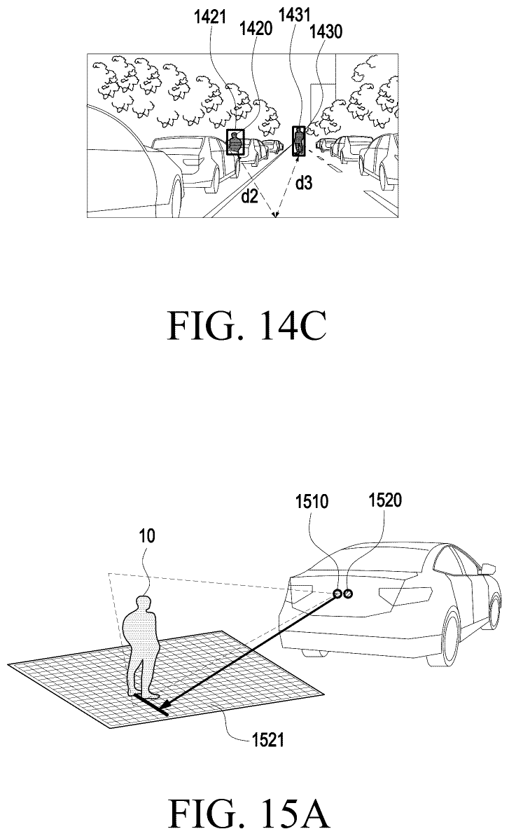

Referring to FIG. 10, if the processor (e.g., the processor 180 of the electronic device of FIG. 1 or the processor 201 of the object detection device of FIGS. 2A to 2C) of the electronic device 100 inputs an image 1010 including an object 1011 as input data to an artificial intelligence model 1020 stored in memory (e.g., the memory 170 of FIG. 1 or the memory 202 of FIGS. 2A to 2C), an object 1031 including a hidden portion may be obtained. For example, if an input image 1010 in which a person's upper body object 1011 is included, and the person's lower body is hidden by a vehicle is input to the artificial intelligence model 1020, the upper body object 1011 in the input image 1010 and a lower body image obtained using the artificial intelligence model 1020 may be coupled, obtaining an output image 1030 including a full body object 1031 including the upper body and the lower body. According to an embodiment, the artificial intelligence model 1020 may obtain, as output data, parameters (e.g., x, y, w, h) related to the object included in the image and a parameter (e.g., h′) related to the portion where the object is hidden. For example, x and y may be parameters related to center coordinates of the rectangular window including the object, w may be a parameter related to the horizontal length of the rectangular window, h may be a parameter related to the vertical length of the rectangular window, and h′ may be a parameter related to the position in contact with the ground in the hidden portion of the object. For example, h′ may be a parameter indicating the entire length of the object including the hidden portion of the object. Further, e.g., for the four parameters indicating the rectangular window, the upper left coordinates (x1, y1) and the upper right coordinates (x2, y2) of the rectangular window may be used instead of x, y, w, and h. According to an embodiment, training data for training the artificial intelligence model 1020 is described below with reference to FIGS. 12, 13A, and 13B. According to an embodiment, an operation of obtaining a distance when an object is not hidden is described with reference to FIG. 14A, an operation of obtaining a distance when a portion of the object is hidden is described with reference to FIG. 14B, and an operation of obtaining a distance from an electronic device when a hidden part is obtained is described with reference to FIG. 14C.

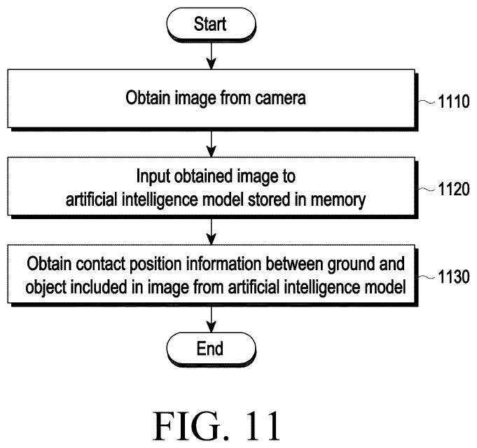

FIG. 11 is a flowchart illustrating an object detection operation of an object detection device according to various embodiments.

Referring to FIG. 11, in operation 1110, the processor (e.g., the processor 180 of the electronic device of FIG. 1 or the processor 201 of the object detection device of FIGS. 2A to 2C) of the electronic device 100 may obtain an image from a camera (e.g., the camera module 121 of FIG. 1 or the camera module 210 of FIGS. 2B to 2C). For example, when the electronic device 100 is a device separate from a camera that captures an image, an image may be obtained from an external camera.

According to an embodiment, in operation 1120, the processor (e.g., the processor 180 of the electronic device of FIG. 1 or the processor 201 of the object detection device of FIGS. 2A to 2C) of the electronic device 100 may input the obtained image to the artificial intelligence model stored in memory (e.g., the memory 212 of FIG. 2 or the memory 202 of FIGS. 2A to 2C). According to an embodiment, the artificial intelligence model may be trained to obtain, as output data, information about a rectangular window including an object included in the input image and information about the position where the object contacts the ground. According to an embodiment, training data input to train an artificial intelligence model is described below with reference to FIGS. 12, 13A, and 13B.

According to an embodiment, in operation 1130, the processor (e.g., the processor 180 of the electronic device of FIG. 1 or the processor 201 of the object detection device of FIGS. 2A to 2C) of the electronic device 100 may obtain information about the contact position between the object included in the image and the ground from the artificial intelligence model. According to an embodiment, the output data obtained from the artificial intelligence model may include four parameters (e.g., x, y, w, and h) related to the rectangular window including the object included in the input image and one parameter (e.g., h′) related to the contact position information between the object and the ground.

According to an embodiment, in operation 1130, when the processor 201 of the object detection device 200 obtains, as output data, information about the rectangular window including the object included in the input image and information about the position where the object contacts the ground, the processor 201 of the object detection device transfers the obtained information to the processor 180 of the electronic device 100. Then, the electronic device 100 may obtain distance information using the obtained information.

According to an embodiment, in operation 1130, the processor 201 of the object detection device 200 may obtain distance information between the electronic device 100 and the object based on the contact position information between the object and the ground, and may transfer the distance information between the electronic device 100 and the object to the processor 180 of the electronic device. According to an embodiment, the distance information between the electronic device 100 and the object may include distance information between the camera (e.g., the camera module 121 of FIG. 1 or the camera module 210 of FIGS. 2B to 2C) of the electronic device 100 and the object.

According to an embodiment, the above-described operations of the object detection device 200 may be performed by the processor 180 of the electronic device 100. According to an embodiment, the processor 180 of the electronic device 100 may obtain an image from a camera (e.g., the camera module 121 of FIG. 1) provided in the electronic device 100, input the image to an artificial intelligence model stored in memory (e.g., the memory 170 of FIG. 1) to obtain five parameters as output data, and obtain a distance to the object using the obtained parameters.

FIG. 12 is a view illustrating an embodiment of training data for training the artificial intelligence model of FIG. 10. FIG. 13A is a view illustrating training data when an object is not hidden according to various embodiments.

Referring to FIG. 12, an image 1210 including an entire object 1211 (e.g., a full body image of a person) may be used as a learning image of an artificial intelligence model (e.g., the artificial intelligence model 1020 of FIG. 10). According to an embodiment, a parameter for the window 1212 corresponding to the object 1211 may be used as training data.

For example, a first learning image 1220 including the entire object 1211, and parameters (x, y, w, h, h′) for the position 1222 where a rectangular window 1221 corresponding to an object 1211 included in the first learning image 1220 and the object contact the ground may be used as the first training data.

According to an embodiment, the first training data may include a vertical length h of the rectangular window 1221 corresponding to the object 1211 and a parameter h′ related to a position 1222 where the object 1211 contacts the ground, and may be h=h′ as illustrated in FIG. 13A. According to an embodiment, since the first learning image 1220 includes the entire unhidden object 1211, a parameter h′ related to the position 1222 where the object 1211 contacts the ground, which has the same value as the vertical length h of the window 1221 corresponding to the object 1211, may be obtained.

Referring back to FIG. 12, according to an embodiment, training data including a partial object 1213 in which a portion of a lower body of an object is hidden may be generated. For example, a second learning image including a partial object 1213 including only a portion of the body, as a portion of the lower body in the first learning image 1210 is hidden by an image patch 1212-2 which is a copy of the peripheral image 1212-1 (e.g., a partial image near the left parking line), and parameters x, y, w, h, and h′ for the position 1232 where the window 1231 corresponding to the partial object 1213 included in the second learning image 1230 and the entire object 1211 contact the ground may be used as the second training data.

FIG. 13B is a view illustrating training data when a portion of an object is hidden according to various embodiments.

According to an embodiment, the second training data may include a vertical length h of the window 1231 corresponding to the partial object 1213 and a parameter h′ related to the position 1232 where the entire object 1211 contacts the ground, and may be h<h′ as illustrated in FIG. 13B. According to an embodiment, the parameter h′ related to the position 1232 where the object contacts the ground may be the parameter h′ obtained from the first training data.

Referring to FIG. 13B, center coordinates (x, y) included in the second training data may be higher than center coordinates (x, y) included in the first training data of FIG. 13A.

Referring back to FIG. 12, a third learning image including a partial object 1213 in which a portion of the lower body in the first learning image 1210 is hidden by a blank box 1214, and parameters x, y, w, h, and h′ for the position 1242 where the window 1241 corresponding to the partial object 1213 included in the third learning image 1240 and the entire object 1211 contact the ground may be used as the third training data. The blank box 1214 may be formed in a single color (e.g., black).

According to an embodiment, the third training data may include a vertical length h of the window 1241 corresponding to the partial object 1213 and a parameter h′ related to the position 1242 where the object 1211 contacts the ground, and may be h<h′ as illustrated in FIG. 13B. According to an embodiment, the parameter h′ related to the position 1242 where the partial object contacts the ground may be the parameter h′ obtained from the first training data.

Although three pieces of training data have been described with reference to FIG. 12, there may be three or more pieces of training data, and the size of the image patch 1212-2 or the blank box 1214 for hiding the lower body of the object may be randomly applied. According to an embodiment, the lower body of the object may be hidden by another object such as a vehicle or a bicycle.

As such, as the training data is generated in such a manner as to hide the lower body of the object in the image including the entire object, the size of the partial object and the position where the object contacts the ground are known, so that five parameters x, y, w, h, and h′ corresponding to the entire object may be automatically generated.

FIG. 14A is a view illustrating a distance measurement operation of an electronic device when an object is not hidden according to various embodiments.

Referring to FIG. 14A, the processor (e.g., the processor 180 of the electronic device of FIG. 1 or the processor 201 of the object detection device of FIGS. 2A to 2C) of the electronic device 100 may obtain a distance d1 between the electronic device 100 and the object 1410 with respect to a lower boundary of a window 1411 corresponding to the object 1410 included in an image obtained through a camera (e.g., the camera module 121 of FIG. 1 or the camera module 210 of FIGS. 2B to 2C). For example, the distance d1 between the electronic device 100 and the object 1410 may be a distance between the electronic device and the lower boundary of the rectangular window 1411.

According to an embodiment, as illustrated in FIG. 14A, because the entire object 1410 is included in the image and the lower boundary of the window 1411 corresponding to the object 1410 is the same as the position where the object 1410 contacts the ground, the distance d1 obtained with respect to the lower boundary of the window 1411 corresponding to the object 1410 has a small error with the actual distance between the electronic device and the object 1410.

FIG. 14B is a view illustrating a conventional distance measurement operation of an electronic device when an object is hidden according to various embodiments.

Referring to FIG. 14B, the processor (e.g., the processor 180 of the electronic device of FIG. 1 or the processor 201 of the object detection device of FIGS. 2A to 2C) of the electronic device 100 may obtain distances d2 and d3 to the plurality of objects 1420 and 1430 with respect to lower boundaries of windows 1421 and 1431 corresponding to the plurality of objects 1420 and 1430 included in an image obtained through a camera (e.g., the camera module 121 of FIG. 1 or the camera module 210 of FIGS. 2B to 2C).

For example, as illustrated in FIG. 14B, at the actual distance, the left object 1420 is positioned ahead of the right object 1430 (i.e., is positioned at a close distance to the electronic device). However, because a lower body portion of the left object 1420 is hidden by another vehicle in the image obtained through the camera, the lower boundary of the window 1421 corresponding to the left object 1420 may be positioned farther than the window 1431 corresponding to the right object 1430, or the lower boundaries of the window 1421 corresponding to the left object 1420 and the window 1431 corresponding to the right object 1430 may be positioned on the same line. If the electronic device or the object detection device obtains the distances d2 and d3 based on the lower boundaries of the window 1421 corresponding to the left object 1420 and the window 1431 corresponding to the right object 1430, the electronic device or the object detection device may misrecognize that the left object 1420 positioned closer to the right object 1430 is farther than the right object 1430, or may misrecognize that they are positioned at the same distance.

FIG. 14C is a view illustrating a distance measurement operation, according to the disclosure, of an electronic device when an object is hidden according to various embodiments.

Referring to FIG. 14C, at least one processor (e.g., the processor 180 of the electronic device of FIG. 1 or the processor 201 of the object detection device of FIGS. 2A to 2C) may predict the hidden portion 1441 by the trained artificial intelligence model (e.g., the artificial intelligence model 1020 of FIG. 10), even if the partial object 1440 partially hidden is included in the image obtained through the camera (e.g., the camera module 121 of FIG. 1 or the camera module 210 of FIGS. 2B to 2C), and obtain the distance d4 between the electronic device and the objects 1440 and 1441 with respect to the lower boundary of the window 1442 corresponding to the object including the predicted portion 1441.

According to an embodiment, at least one processor (e.g., the processor 180 of the electronic device of FIG. 1 or the processor 201 of the object detection device of FIGS. 2A to 2C) may display the prediction result of the hidden portion 1441 of the object on the image in a silhouette or translucent manner. For example, by displaying, on the left object 1420, the image of the upper body of the person and the prediction result of the hidden portion as a silhouette or translucent image, the image of the upper body of the person, actually captured, and the predicted lower body may be distinguished from each other. Accordingly, the user of the electronic device may easily recognize the predicted image of the lower body.

As described above, because the artificial intelligence model predicts the contact position between the ground and the hidden portions of the object and obtains the distance between the object and the electronic device with respect to the predicted contact position with the ground, a more accurate distance to the object may be obtained.

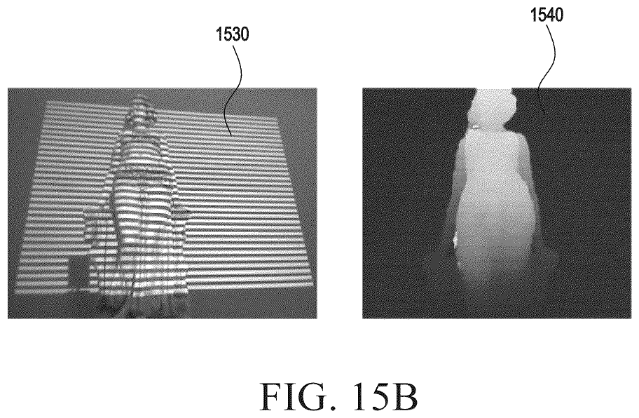

FIG. 15A is a view illustrating an operation of measuring a distance to an object through a camera and patterned light by an electronic device according to various embodiments.

Referring to FIG. 15A, the processor (e.g., the processor 180 of the electronic device of FIG. 1 or the processor 201 of the object detection device of FIGS. 2A to 2C) of the electronic device 100 may obtain a distance between the electronic device 100 and the object 10 through a camera 1510 (e.g., the camera module 121 of FIG. 1 or the camera module 210 of FIGS. 2B to 2C) and lighting 1520 (e.g., pattern lighting). FIG. 15A illustrates an example in which the electronic device (e.g., the electronic device 100 of FIG. 1) is mounted in a vehicle, and a single camera 1510 (e.g., the camera module 121 of FIG. 1) and lighting 1520 (e.g., pattern lighting) are positioned on the rear surface of the vehicle.

According to an embodiment, the electronic device 100 may dispose the pattern lighting 1520 of a visible light wavelength band next to the camera 1510, and operate the pattern lighting 1520 and the camera 1510 together when moving backward in a low-light environment at night to obtain an image in a state in which patterned light is radiated. According to an embodiment, the pattern lighting 1520 may be projected toward the ground. The camera 1510 may be a wide-angle camera.

According to an embodiment, the electronic device 100 may detect the patterned light 1521 projected onto the ground and the end of the object 10 to more accurately measure the position of the object 10 (e.g., the distance between the electronic device and the object) even at night.

According to an embodiment, the pattern lighting 1520 may serve as auxiliary lighting for object recognition in a dark environment.

According to an embodiment, the electronic device 100 may obtain a distance to the object through an image obtained by photographing the patterned light 1521 projected onto the ground using the artificial intelligence model. For example, the artificial intelligence model may be trained using the image obtained by projecting the pattern lighting 1520 onto a conventional nighttime low-illuminance image as training data.

As such, the pattern lighting 1520 projected onto the ground is mounted so that the direction of the lighting faces the bottom surface, so that the electronic device may accurately measure the bottom surface of the object as well as estimate the distance by the pattern projected onto the object, thereby measuring the distance more accurately than the conventional method.

FIG. 15B is a view illustrating an image obtained by the operation of FIG. 15A.

Referring to FIG. 15B, the electronic device 100 may project patterned light in the visible wavelength band and obtain an image 1530 in which patterned light is projected through a camera (e.g., the camera module 121 of FIG. 1) that photographs light in the visible wavelength band.

According to an embodiment, the electronic device 100 may project patterned light in the infrared wavelength band and obtain an image 1540 in which patterned light is projected through a camera that photographs light in the infrared wavelength band.

According to an embodiment, the electronic device 100 may obtain the distance between the electronic device 100 and the object by analyzing the pattern included in the obtained images 1530 and 1540, and obtain the distance to the object as output data by inputting the same to the trained artificial intelligence model.

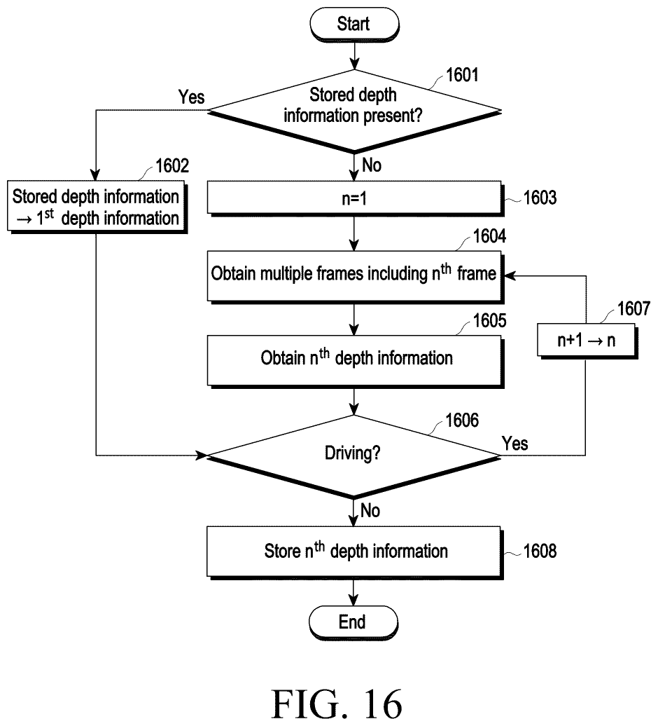

FIG. 16 is a flowchart illustrating an operation of obtaining depth information by an electronic device according to various embodiments.

Referring to FIG. 16, an operation in which the electronic device 100 obtains depth information about a frame captured through a camera is described. Depth information is information related to a distance between an electronic device and an object. For a 2D image frame obtained through a single camera, depth information may be obtained using, e.g., deep learning or through a known algorithm.

First, the processor (e.g., the processor 180 of the electronic device of FIG. 1 or the processor 201 of the object detection device of FIGS. 2A to 2C) of the electronic device 100 may identify whether there is stored depth information in operation 1601. For example, depth information stored in memory (e.g., the memory 170 of FIG. 1 or the memory 202 of FIGS. 2A to 2C) may be depth information obtained from an image frame last captured through a camera (e.g., the camera module 121 of FIG. 1 or the camera module 210 of FIGS. 2B to 2C) before the electronic device 100 which is running is turned off. According to an embodiment, operation 1601 may be an operation immediately after the electronic device (e.g., a vehicle) is turned on.

According to an embodiment, if there is the stored depth information (Yes in operation 1601), in operation 1602, the processor (e.g., the processor 180 of the electronic device of FIG. 1 or the processor 201 of the object detection device of FIGS. 2A to 2C) of the electronic device 100 may obtain the stored depth information as initial depth information (1st depth information). Thereafter, the processor of the electronic device 100 (e.g., the processor 180 of the electronic device of FIG. 1 or the processor 201 of the object detection device of FIGS. 2A to 2C) may proceed to operation 1606 to identify whether the electronic device 100 is being driven. Operation 1606 is described in more detail below.

According to an embodiment, when there is no stored depth information (No in operation 1601), in operation 1603, the electronic device 100 may set n to 1.

According to an embodiment, in operation 1604, the processor (e.g., the processor 180 of the electronic device of FIG. 1 or the processor 201 of the object detection device of FIGS. 2A to 2C) of the electronic device 100 may obtain a plurality of image frames including an nth frame, continuously captured using a camera (e.g., the camera module 121 of FIG. 1 or the camera module 210 of FIGS. 2B to 2C). According to an embodiment, the electronic device 100 may obtain a plurality of image frames continuously captured while moving.

According to an embodiment, in operation 1605, the processor (e.g., the processor 180 of the electronic device of FIG. 1 or the processor 201 of the object detection device of FIGS. 2A to 2C) of the electronic device 100 may obtain nth depth information based on the plurality of image frames.

According to an embodiment, in operation 1606, the processor (e.g., the processor 180 of the electronic device of FIG. 1 or the processor 201 of the object detection device of FIGS. 2A to 2C) of the electronic device 100 may determine whether the electronic device 100 is driven. For example, when the electronic device 100 is moving or powers on, the processor (e.g., the processor 180 of the electronic device of FIG. 1 or the processor 201 of the object detection device of FIGS. 2A to 2C) of the electronic device 100 may determine that the electronic device 100 is being driven. According to an embodiment, when the electronic device 100 is powered off, the electronic device may determine that the electronic device is not being driven.

According to an embodiment, when the electronic device 100 is being driven (Yes in operation 1606), in operation 1607, the processor (e.g., the processor 180 of the electronic device of FIG. 1 or the processor 201 of the object detection device of FIGS. 2A to 2C) of the electronic device 100 may set n+1 to n, and may return to operation 1604 to repeatedly obtain a plurality of image frames and depth information.

According to an embodiment, if the electronic device 100 is not being driven (No in 1606), in operation 1608, the processor (e.g., the processor 180 of the electronic device of FIG. 1 or the processor 201 of the object detection device of FIGS. 2A to 2C) of the electronic device 100 may store the last obtained nth depth information in memory (e.g., the memory 170 of FIG. 1 or the memory 202 of FIGS. 2A to 2C).

As such, when the depth information is computed with one camera, more accurate depth information may be obtained from a moving image rather than a still image. Therefore, if the depth information is computed with the first captured image after the stopped vehicle is powered on, the depth information is obtained from the still image and the accuracy is reduced. On the other hand, according to the disclosure, the last depth information obtained during the previous driving or before power off is stored, and when powered on afterwards, the stored depth information is used as the initial depth information and, for the initial depth information and the depth information obtained for the new incoming frame, only changed depth information is updated, thereby enhancing the accuracy of the depth information obtained when powered off and then powered back on.

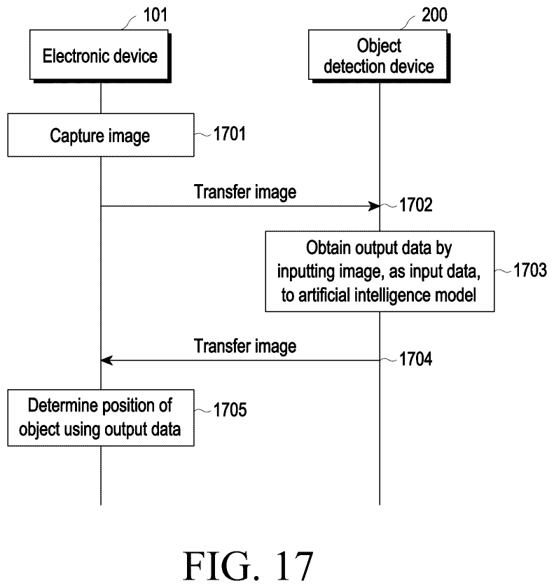

FIG. 17 is a flowchart illustrating an embodiment in which an object detection device 200 (e.g., the object detection device 200 of FIG. 2A) included in an electronic device 100, as a component distinguished from a processor (e.g., the processor 180 of FIG. 1) of the electronic device 100, performs an object detection operation. For example, FIG. 17 illustrates an operation in which the object detection device 200 detects an object for an input image using an artificial intelligence model (e.g., the artificial intelligence model 310 of FIG. 3 or the artificial intelligence model 1020 of FIG. 10) stored in memory (e.g., the memory 202 of FIG. 2A) of the object detection device 200, which is a component distinguished from memory (e.g., the memory 170 of FIG. 1) of the electronic device 100.

Referring to FIG. 17, the electronic device 100 (e.g., the electronic device 100 of FIG. 1 or the processor 180 of FIG. 1) may capture an image using a camera module (e.g., the camera module 121 of FIG. 1) in operation 1701. According to an embodiment, the electronic device 100 may capture an image from a camera module that is a component separate from the object detection device 200.

According to an embodiment, in operation 1702, the electronic device 100 may transfer the captured image to the object detection device 200.

According to an embodiment, in operation 1703, the object detection device 200 may obtain output data by inputting the image to the artificial intelligence model as input data. According to an embodiment, the object detection device 200 may input an image to the trained artificial intelligence model as input data, and obtain a parameter related to a window of five or more angles of the object included in the input image or a parameter related to the position where the object contacts the ground as output data.

According to an embodiment, in operation 1704, the object detection device 200 may transmit the output data to the electronic device 100.

According to an embodiment, in operation 1705, the electronic device 100 may determine the position of the object using the output data. According to an embodiment, the electronic device 100 may determine the distance between the electronic device 100 and the object and/or the position of the object relative to the position of the electronic device 100 based on the parameter received from the object detection device 200.

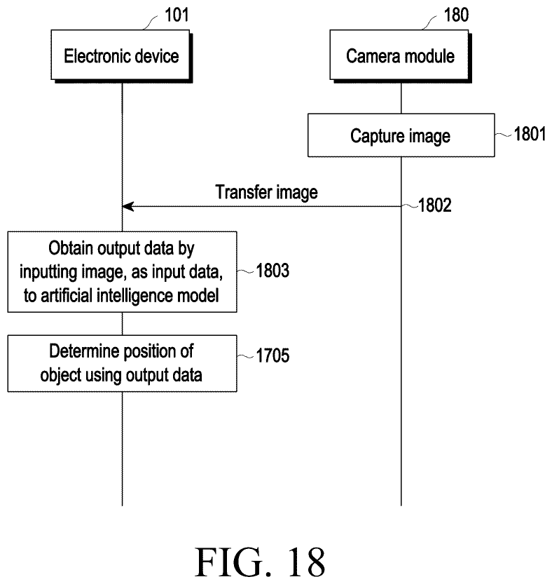

FIG. 18 is a flowchart illustrating an embodiment of performing an object detection operation through a processor (e.g., the processor 180 of FIG. 1) of an electronic device 100 according to various embodiments. For example, FIG. 18 illustrates an operation in which an electronic device 100 (e.g., the electronic device 100 of FIG. 1 or the processor 180 of FIG. 1) recognizes an object for an input image using an artificial intelligence model (e.g., the artificial intelligence model 310 of FIG. 3 or the artificial intelligence model 1020 of FIG. 10) stored in memory (e.g., the memory 170 of FIG. 1).

Referring to FIG. 18, in operation 1801, the camera 121 (e.g., the camera module 121 of FIG. 1) of the electronic device 100 may capture an image.

According to an embodiment, in operation 1802, the camera 121 may transfer the captured image to the electronic device 100 (or the processor 180).

According to an embodiment, in operation 1803, the electronic device 100 may obtain output data by inputting the image to the artificial intelligence model as input data. According to an embodiment, the electronic device 100 may input an image to the trained artificial intelligence model as input data, and obtain a parameter related to a window of five or more angles of the object included in the input image or a parameter related to the position where the object contacts the ground as output data.

According to an embodiment, in operation 1804, the electronic device 100 may determine the position of the object using the output data. According to an embodiment, the electronic device 100 may determine the distance between the electronic device 100 and the object and/or the position of the object relative to the position of the electronic device 100 based on the parameter obtained through the artificial intelligence model.

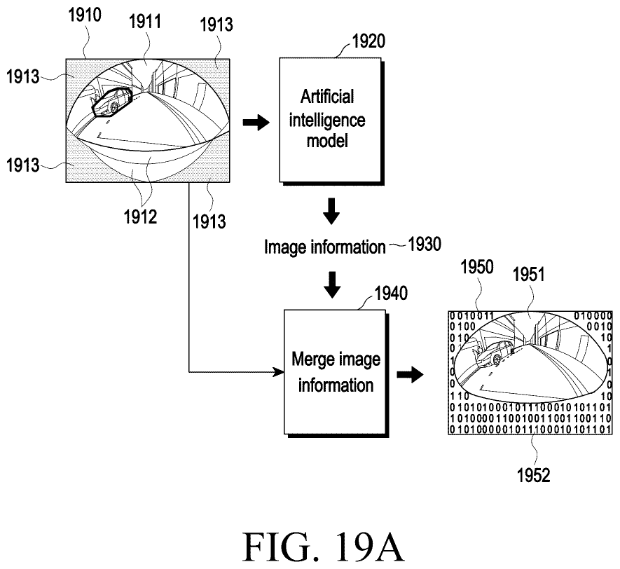

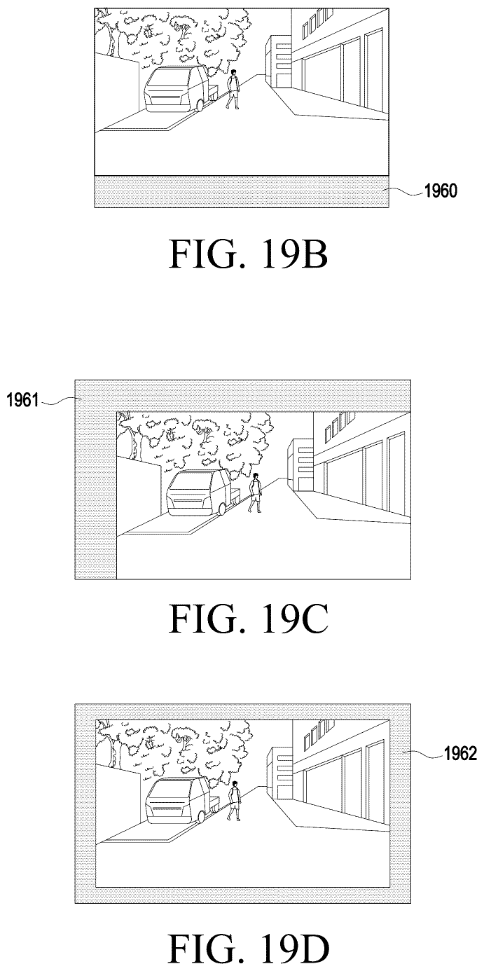

FIG. 19A is a view illustrating an operation in which an electronic device includes image information in an image frame according to various embodiments.

Referring to FIG. 19, the processor (e.g., the processor 180 of the electronic device of FIG. 1 or the processor 201 of the object detection device of FIGS. 2A to 2C) of the electronic device 100 may obtain an input image 1910. According to an embodiment, the input image 1910 may be a moving image including a plurality of frames.

According to an embodiment, the processor (e.g., the processor 180 of the electronic device of FIG. 1 or the processor 201 of the object detection device of FIGS. 2A to 2C) of the electronic device 100 may obtain the image stored in memory (e.g., the memory 170 of FIG. 1 or the memory 202 of FIGS. 2A to 2C) as the input image 1910 input as input data to at least one artificial intelligence model 1920. For example, when the electronic device 100 does not include a camera module (e.g., the camera module 121 of FIG. 1) that captures an image, the electronic device 100 may obtain an image from an external camera. According to an embodiment, when the electronic device 100 includes a camera module, the electronic device 100 may obtain an image from a lens and an image sensor included in the camera module.

According to an embodiment, the input image 1910 input as input data to the artificial intelligence model 1920 may include an area 1911 that requires object detection and areas 1912 and 1913 that do not require object detection. According to an embodiment, the area 1911 that requires object detection may be an image in which content changes in real time as the electronic device 100 moves when capturing a moving image, and may be an area in which an image capturing a surrounding environment is displayed. The areas 1912 and 1913 that do not require object detection may be areas in which content does not change in real time when photographing a moving image. According to an embodiment, when the electronic device is a vehicle and the camera is installed on the rear surface of the vehicle, e.g., in the input image 1910 of FIG. 19, areas 1912 and 1913 that do not require object detection may include a first area 1912, which is a housing area near where the camera is installed, and a second area 1913, which is a blank area without an image. According to an embodiment, when the electronic device is a vehicle, the first area 1912 may be a bumper area around which a camera is installed.

According to an embodiment, the input image 1910 may be obtained through a fisheye camera. Because a circular (or elliptical) image is obtained due to the nature of the fisheye camera, four corners of the rectangular image obtained through the fisheye camera may include a second area 1913 which is a blank area having no pixel value. According to an embodiment, the processor of the electronic device may identify an area having no pixel value at four corners of the image 1910 as the second area 1913.

According to an embodiment, when a wide-angle camera is mounted on an electronic device (e.g., a vehicle), a bumper (e.g., a front bumper or a rear bumper) should be mounted to be visible according to the rule. Accordingly, the image 1910 obtained through the camera may include a bumper area 1912 in which a portion of the bumper that is irrelevant to the surrounding environment information and remains unchanged as the electronic device moves is displayed.

According to an embodiment, since the position and the angle are determined when the camera is mounted, the position and/or the size of the area corresponding to the blank area 1913 and/or the bumper area 1912 may be input by the user (or the manufacturer). According to an embodiment, the processor of the electronic device may identify the blank area 1913 and/or the bumper area 1912, which does not require object detection, based on the blank area 1913 and/or the bumper area 1912 input by the user (or the manufacturer).

According to an embodiment, even if the image of the bumper area 1912 included in the image is partially changed, such as when snow accumulates, water droplets form, or flies sit on the bumper, the actual bumper area is fixed, and thus the position and/or size of the bumper area 1912 in the image in which the image information is to be written may be fixed as an input value. For example, even if the image of the bumper area 1912 included in the image is partially changed, such as when snow accumulates, water droplets form, or flies sit on the bumper, the processor of the electronic device may write the image information in the same area as the bumper area 1912 before the change in the image.

FIG. 19B is a view illustrating an operation of generating a blank area in an image according to various embodiments.

FIG. 19C is a view illustrating an operation of generating a blank area in an image according to various embodiments.

FIG. 19D is a view illustrating an operation of generating a blank area in an image according to various embodiments.

Referring to FIG. 19B, FIG. 19C, or FIG. 19D, when there are no blank area 1913 and a bumper area 1912 in an image, the processor of the electronic device may increase the size of the image so that a blank area is generated in at least one edge area of the obtained image. For example, when the blank area 1913 and the bumper area 1912 are not present in the image, the processor of the electronic device may generate the blank area 1960 on a lower side of the obtained image, as illustrated in FIG. 19B.

According to an embodiment, as shown in FIG. 19C, the processor of the electronic device may generate blank areas 1961 on an upper side and a left side of the obtained image.

According to an embodiment, as illustrated in FIG. 19D, the processor of the electronic device may generate blank areas 1962 on the upper side, the lower side, the left side, and the right side of the obtained image, and may identify the generated blank areas as areas 1912 and 1913 that do not require object detection. According to an embodiment, the blank areas 1960, 1961, and 1962 of FIGS. 19B to 19D are merely an embodiment, and the position and/or size of the blank areas is not limited thereto.

According to an embodiment, the image 1910 may include a plurality of frames. According to an embodiment, the processor of the electronic device may identify an area in which a pixel value difference corresponding to at least two frames among the plurality of frames of the image 1910 is within a set range and/or an area within a set distance as the first area 1912 which is a bumper area. According to an embodiment, the processor of the electronic device may identify an area in which a corresponding pixel value difference between at least two or more frames of an area other than the second area 1913 of the image 1910 is within a set range and/or an area within a distance set based on distance information included in the image information 1930 as the first area 1912 which is a bumper area.

According to an embodiment, when the processor (e.g., the processor 180 of FIG. 1) of the electronic device and the processor (e.g., the processor 201 of FIGS. 2A to 2C) of the object detection device are separate components, the operation of identifying the first area 1912 and the second area 1913 may be performed by the processor 201 of the object detection device, or information about the first area 1912 and the second area 1913 may be received from the processor (e.g., the processor 180 of FIG. 1) of the electronic device, which is different from the object detection device.

According to an embodiment, the processor of the electronic device may input the image 1910 as input data to at least one artificial intelligence model 1920 stored in memory (e.g., the memory 170 of FIG. 1 or the memory 202 of FIGS. 2A to 2C) to obtain image information 1930 about the image 1910 as output data. According to an embodiment, the at least one artificial intelligence model 1920 may be trained to obtain image information including object detection information, drivable road information, and/or distance information to the object included in the image 1910, which is input data, as output data.

According to an embodiment, although FIG. 19 illustrates that image information 1930 is obtained through at least one artificial intelligence model 1920, the image information 1930 may be obtained by various methods other than the at least one artificial intelligence model 1920. For example, as illustrated in FIGS. 15A and 15B, distance information to the object obtained using pattern lighting (e.g., the pattern lighting 1520 of FIG. 15) may be obtained as image information 1930.

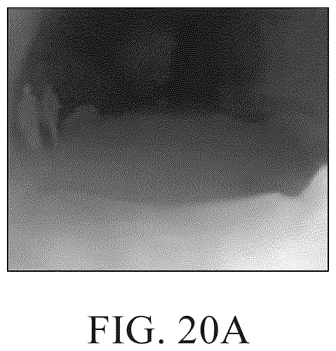

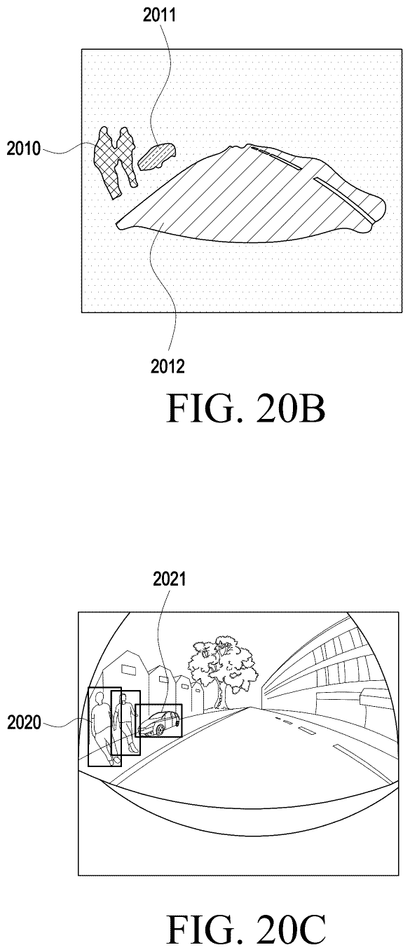

According to an embodiment, the image information 1930 may include at least one of distance information for each pixel of the input image 1910, drivable road information, or object information included in the input image 1910. According to an embodiment, per-pixel distance information about the input image 1910 is described with reference to FIG. 20A, drivable road information about the input image 1910 is described with reference to FIG. 20B, and object information included in the input image 1910 is described with reference to FIG. 20C.

According to an embodiment, in operation 1940, the processor of the electronic device may obtain a merged image 1950 through merging of the input image 1910 and the image information 1930. According to an embodiment, the processor of the electronic device may specify (e.g., write) image information about the area 1911 requiring object detection in the first area 1912 and the second area 1913 of the input image 1910.

According to an embodiment, the merged image 1950 may include an area 1951 in which the object is detected and an area 1952 in which image information is written. According to an embodiment, the area 1951 in which object detection is performed may correspond to the area 1911 in which object detection of the input image 1910 is required, and the area 1952 in which image information is written may correspond to the first area 1912 and the second area 1913 in which object detection of the input image 1910 is not required.

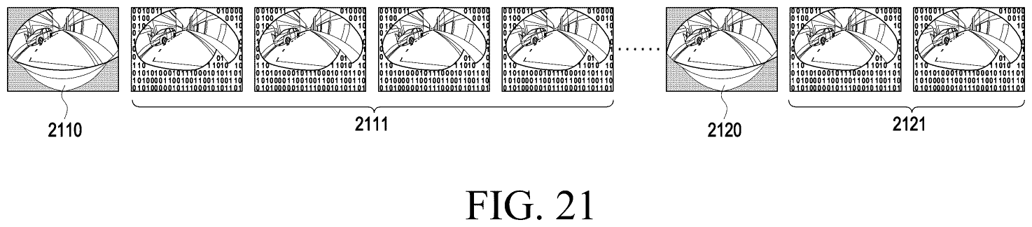

According to an embodiment, the processor of the electronic device may not merge the image information 1930 in at least one of the plurality of frames of the input image 1910. According to an embodiment, the processor of the electronic device may identify the first area 1912 of the input image 1910 based on at least one frame in which image information is not merged among the plurality of frames of the input image 1910. According to an embodiment, the processor of the electronic device may identify the first area 1912 included in the input image 1910 based on a set period, and may not merge image information in at least one frame corresponding to the set period among the plurality of frames. According to an embodiment, a structure of a plurality of frames including a frame in which image information is merged and a frame in which image information is not merged is described below with reference to FIG. 21.

According to an embodiment, when the processor (e.g., the processor 180 of FIG. 1) of the electronic device and the processor (e.g., the processor 201 of FIGS. 2A to 2C) of the object detection device are separate components, the processor of the object detection device may transmit the image 1950 in which the image information is merged to an application processor (AP) (e.g., the processor 180 of FIG. 1) different from the object detection device.

As such, by writing and transmitting image recognition information in a meaningless area (e.g., a blank area, a housing area, or a bumper area) of an image, it is possible to reduce resources consumed as compared with when transmitting each of the image and the recognition information and to enhance the transmission speed.

FIG. 20A is a view illustrating distance information of an image according to various embodiments.

Referring to FIG. 20A, the processor (e.g., the processor 180 of FIG. 1 or the processor 201 of FIGS. 2A to 2C) of the electronic device may obtain distance information for each pixel of an image through an artificial intelligence model. For example, FIG. 20A illustrates an image in which a pixel close in distance is displayed bright and a pixel far away is displayed dark to describe distance information for each pixel, but the processor of the electronic device does not necessarily need to obtain the image illustrated in FIG. 20A, but may obtain only distance information for each pixel.

According to an embodiment, the processor of the electronic device may obtain distance information from an object included in the image through a stereo image, an infrared ray, a visible ray, and/or an ultrasonic wave, even without using an artificial intelligence model.

FIG. 20B is a view illustrating drivable road information of an image according to various embodiments.

Referring to FIG. 20B, the processor of the electronic device may obtain drivable road information of an image through an artificial intelligence model. For example, the artificial intelligence model may be trained to obtain semantic segmentation information as output data. For example, the processor of the electronic device may identify the type (e.g., person 2010, vehicle 2011, road 2012, and bicycle) of the object included in the image based on the semantic segmentation information obtained as the output data in response to inputting the image to the artificial intelligence model, and obtain the drivable road information 2012.

FIG. 20C is a view illustrating object information of an image according to various embodiments.

Referring to FIG. 20C, the processor of the electronic device may obtain object information of an image through an artificial intelligence model. According to an embodiment, the processor of the electronic device may display the window 2020 or 2021 for the object detected from the image based on the object information of the image obtained as output data of the at least one artificial intelligence model. For example, when the object information of the image is four parameters for the detected object, a rectangular window may be displayed as shown in FIG. 20C. According to an embodiment, the object information of the image may further include object type information (e.g., person or vehicle). According to an embodiment, the processor of the electronic device may further display the object type information along with the window display on the image.

According to an embodiment, in FIG. 20C, the window is illustrated as being rectangular, but as illustrated in FIG. 6B or 7B, the window may be a polygonal window of five or more angles. According to an embodiment, the object information, which is output data of the artificial intelligence model, may include information related to an object detected as a polygonal window of five or more angles. For example, the window may be a hexagonal or octagonal polygonal window. According to an embodiment, the hexagonal or octagonal polygonal window may overlap each of four sides included in one rectangle (e.g., a rectangular window).

According to an embodiment, in response to inputting an image to a first artificial intelligence model among at least one artificial intelligence model, the processor of the electronic device may obtain polygonal window information of five or more angles (e.g., a hexagon or an octagon) as output data of the first artificial intelligence model. According to an embodiment, the first artificial intelligence model (e.g., the artificial intelligence model 310 of FIG. 3) may be trained to input, as training data, learning image and five or more (e.g.,. hexagonal or octagonal) parameters obtained using first annotation information of a rectangular bounding box type of the learning image and second annotation information of a segmentation type of the learning image to obtain, as output data, five or more (e.g., hexagonal or octagonal) parameters related to the polygonal window indicating the object included in the image which is the input data. According to an embodiment, when a moving image is input to the first artificial intelligence model as input data, each of a plurality of frames of the moving image may be input as input data. According to an embodiment, image information about each of the plurality of frames included in the moving image may be obtained as output data of the first artificial intelligence model.

According to an embodiment, the object information that is output data of the at least one artificial intelligence model may further include contact position information between the object and the ground.

According to an embodiment, in response to inputting the image to the second artificial intelligence model (e.g., the artificial intelligence model 1020 of FIG. 10) among the at least one artificial intelligence model, the processor of the electronic device may obtain contact position information between the object and the ground as output data of the second artificial intelligence model. According to an embodiment, the second artificial intelligence model may be trained to input, as training data, a first learning image including a first object, position information about the first object, contact position information between the first object and the ground, a second learning image including a second object where the contact position between the first object and the ground is hidden, position information about the second object and contact position information between the second object and the ground to output, as output data, contact position information between the ground and the object included in the image which is the input data. According to an embodiment, when a moving image is input to the second artificial intelligence model as input data, each of a plurality of frames of the moving image may be input as input data. According to an embodiment, image information about each of the plurality of frames included in the moving image may be obtained as output data of the second artificial intelligence model.

According to an embodiment, the processor of the electronic device may obtain distance information to the detected object based on the contact position information between the object and the ground.

FIG. 21 is a view illustrating a structure of an image frame including image information according to various embodiments.

Referring to FIG. 21, information about an input image (e.g., the input image 1910 of FIG. 19) may be included in at least one frame 2111 and 2121 among the plurality of frames 2110, 2111, 2120, and 2121 included in the merged image (e.g., the merged image 1950 of FIG. 19), and information about the input image (e.g., the input image 1910 of FIG. 19) may not be included in the at least one image frame 2110 and 2120. The input image is a moving image obtained by the electronic device, and may include a plurality of input frames obtained through a camera included in the electronic device. The merged image may be a moving image corresponding to the input image, and may include a plurality of frames 2110, 2111, 2120, and 2121 corresponding to the plurality of input frames.

According to an embodiment, the processor (e.g., the processor 180 of FIG. 1 or the processor 201 of FIGS. 2A to 2C) of the electronic device may identify a change in the bumper area (e.g., the bumper area 1912 of FIG. 19) by periodically outputting the image frames 2110 and 2120 that do not include information about the input image.

According to an embodiment, the processor of the electronic device may include the information about the input image in the image frames 2111 and 2121 other than the image frames 2110 and 2120 that do not include the information about the input image.

According to an embodiment, the merged image may be displayed on a display (e.g., the display 151 of FIG. 1) or stored in memory (e.g., the memory 170 of FIG. 1) under the control of a processor (e.g., the processor 180 of FIG. 1).

According to an embodiment, the electronic device may maintain the display of the blank area and the bumper area obtained from the image frames 2110 and 2120 that do not include the information about the input image, and may change only the area in which the object of the image frames 2110 and 2120 that do not include the information about the input image is detected into the image of the area in which the object of the image frames 2111 and 2121 with the image information written is detected (e.g., the area 1951 in which the object of FIG. 19 is detected) and display the same.

According to an embodiment, the processor (e.g., the processor 180 of the electronic device of FIG. 1 or the processor 201 of the object detection device of FIGS. 2A to 2C) of the electronic device 100 may maintain the display of the blank area and the bumper area image of the first image frame 2110 not including input image information, change the image of the area where the object of the first image frame 2110 is detected into the image of the area (e.g., the area 1951 in which the object of FIG. 19 is detected) in which the object of the second image frame 2111 is detected and display the same, display the blank area and bumper area images of the third image frame 2120 not including input image information, and change the image of the area in which the object of the third image frame 2120 is detected into the image of the area (e.g., the area 1951 in which the object of FIG. 19 is detected) in which the object of the fourth image frame 2121 is detected and display the same.

As described above, by including the information about the image and transferring the information in the meaningless area of the image, the amount of data transmitted may be reduced as compared with when separately transmitting the image and image information.

Further, by periodically outputting the frame actually including the image of the bumper area, the image reflecting the change in the actual bumper area may be displayed.

According to various embodiments, an object detection device may comprise memory, at least one processor operatively connected to the memory. The at least one processor may obtain a moving image, identify an area where content changes in real time and an area where the content does not change in real time, as included in the moving image, obtain image information about the moving image, and merge the image information into the area where the content does not change in real time.

According to an embodiment, the image may be received from a camera module different from the object detection device.

According to an embodiment, the image information may include at least one of per-pixel distance information about the moving image, drivable road information, or information about an object included in the moving image.

According to an embodiment, the object information may include information related to an object detected as a polygonal window of a hexagon or an octagon.

According to an embodiment, four sides included in the polygonal window may overlap four sides, respectively, included in one rectangle.

According to an embodiment, the at least one processor may obtain information about the polygonal window of the hexagon or the octagon as output data of a first artificial intelligence model among at least one artificial intelligence model stored in the memory, in response to inputting the moving image, as input data, to the first artificial intelligence model. The first artificial intelligence model may be trained to input, as training data, a learning image and six or eight parameters related to a polygonal window obtained using first annotation information of a rectangular bounding box type of the learning image and second annotation information of a segmentation type of the learning image, to output, as output data, six or eight parameters related to a polygonal window indicating an object included in an image which is input data.

According to an embodiment, the object information may further include contact position information between the object and a ground. The at least one processor may obtain the contact position information between the object and the ground, as output data of a second artificial intelligence model among at least one artificial intelligence model stored in the memory, in response to inputting the moving image, as input data, to the second artificial intelligence model. The second artificial intelligence model may be trained to input, as training data, a first learning image including a first object, position information about the first object, contact position information between the first object and the ground, a second learning image including a second object where a contact position between the first object and the ground is hidden, position information about the second object, and contact position information between the second object and the ground to obtain, as output data, contact position information between the ground and the object included in an image which is input data.

According to an embodiment, the moving image may include a plurality of frames. The at least one processor may identify an area where a pixel value difference corresponding to at least two or more frames among the plurality of frames is within a set range and/or an area within a set distance as the area where the content does not change in real time.

According to an embodiment, the at least one processor may identify a blank area with no pixel value in four corners of the moving image as the area where the content does not change in real time.

According to an embodiment, the at least one processor may transmit a moving image where the image information is merged to an application processor different from the object detection device.

According to an embodiment, the at least one processor may identify the area where the content does not change in real time, based on a set period.

According to an embodiment, in a non-transitory computer-readable recording medium storing one or more programs, the one or more programs may comprise instructions that, when executed by a processor of an object detection device, enable the processor to: obtain a moving image, identify an area where content changes in real time and an area where the content does not change in real time, as included in the moving image, obtain image information about the moving image, and merge the image information into the area where the content does not change in real time.

According to an embodiment, the moving image may be received from a camera module different from the object detection device.

According to an embodiment, the image information may include at least one of per-pixel distance information about the moving image, drivable road information, or information about an object included in the moving image.

According to an embodiment, the object information may include information related to an object detected as a polygonal window of a hexagon or an octagon.

According to an embodiment, four sides included in the polygonal window may overlap four sides, respectively, included in one rectangle.

According to an embodiment, the one or more programs may comprise instructions that, when executed by the processor, enable the processor to obtain information about the polygonal window of the hexagon or the octagon as output data of a first artificial intelligence model among at least one artificial intelligence model stored in the memory, in response to inputting the moving image, as input data, to the first artificial intelligence model. The first artificial intelligence model may be trained to input, as training data, a learning image and six or eight parameters related to a polygonal window obtained using first annotation information of a rectangular bounding box type of the learning image and second annotation information of a segmentation type of the learning image, to output, as output data, six or eight parameters related to a polygonal window indicating an object included in an image which is input data.

According to an embodiment, the object information may further include contact position information between the object and a ground. The one or more programs may comprise instructions that, when executed by the processor, enable the processor to obtain the contact position information between the object and the ground, as output data of a second artificial intelligence model among at least one artificial intelligence model stored in the memory, in response to inputting the moving image, as input data, to the second artificial intelligence model. The second artificial intelligence model may be trained to input, as training data, a first learning image including a first object, position information about the first object, contact position information between the first object and the ground, a second learning image including a second object where a contact position between the first object and the ground is hidden, position information about the second object, and contact position information between the second object and the ground to obtain, as output data, contact position information between the ground and the object included in an image which is input data.

According to an embodiment, the moving image may include a plurality of frames. The one or more programs may comprise instructions that, when executed by the processor, enable the processor to identify an area where a pixel value difference corresponding to at least two or more frames among the plurality of frames is within a set range and/or an area within a set distance as the area where the content does not change in real time.

According to an embodiment, the one or more programs may comprise instructions that, when executed by the processor, enable the processor to identify a blank area with no pixel value in four corners of the moving image as the area where the content does not change in real time.

According to an embodiment, the one or more programs may comprise instructions that, when executed by the processor, enable the processor to transmit a moving image where the image information is merged to an application processor different from the object detection device.

According to an embodiment, The one or more programs may comprise instructions that, when executed by the processor, enable the processor to identify the area where the content does not change in real time, based on a set period.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 100). For example, a processor (e.g., the processor 180) of the machine (e.g., the electronic device 100) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™M), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An object detection device, comprising:
memory; and
at least one processor operatively connected to the memory, wherein the at least one processor:
obtains a moving image;
identifies an area where content changes in real time and an area where the content does not change in real time, as included in the moving image;
obtains image information about the moving image; and
merges the image information into the area where the content does not change in real time.

2. The object detection device of claim 1, wherein the moving image is received from a camera module different from the object detection device.

3. The object detection device of claim 1, wherein the image information includes at least one of per-pixel distance information about the moving image, drivable road information, or information about an object included in the moving image.

4. The object detection device of claim 3,
wherein the object information includes information related to an object detected as a polygonal window of a hexagon or an octagon, and
wherein four sides included in the polygonal window overlap four sides, respectively, included in one rectangle.

5. The object detection device of claim 4,
wherein the at least one processor obtains information about the polygonal window of the hexagon or the octagon as output data of a first artificial intelligence model among at least one artificial intelligence model stored in the memory, in response to inputting the moving image, as input data, to the first artificial intelligence model, and
wherein the first artificial intelligence model is trained to input, as training data, a learning image and six or eight parameters related to a polygonal window obtained using first annotation information of a rectangular bounding box type of the learning image and second annotation information of a segmentation type of the learning image, to output, as output data, six or eight parameters related to a polygonal window indicating an object included in an image which is input data.

6. The object detection device of claim 4,
wherein the object information further includes contact position information between the object and a ground,
wherein the at least one processor obtains the contact position information between the object and the ground, as output data of a second artificial intelligence model among at least one artificial intelligence model stored in the memory, in response to inputting the moving image, as input data, to the second artificial intelligence model, and
wherein the second artificial intelligence model is trained to input, as training data, a first learning image including a first object, position information about the first object, contact position information between the first object and the ground, a second learning image including a second object where a contact position between the first object and the ground is hidden, position information about the second object, and contact position information between the second object and the ground to obtain, as output data, contact position information between the ground and the object included in an image which is input data.

7. The object detection device of claim 1,
wherein the moving image includes a plurality of frames, and
wherein the at least one processor identifies an area where a pixel value difference corresponding to at least two or more frames among the plurality of frames is within a set range and/or an area within a set distance as the area where the content does not change in real time.

8. The object detection device of claim 1, wherein the at least one processor identifies a blank area with no pixel value in four corners of the moving image as the area where the content does not change in real time.

9. The object detection device of claim 1, wherein the at least one processor transmits a moving image where the image information is merged to an application processor different from the object detection device.

10. The object detection device of claim 1, wherein the at least one processor identifies the area where the content does not change in real time, based on a set period.

11. A non-transitory computer-readable recording medium storing one or more programs,
wherein the one or more programs comprise instructions that, when executed by a processor of an object detection device, enable the processor to:
obtain a moving image;
identify an area where content changes in real time and an area where the content does not change in real time, as included in the moving image;
obtain image information about the moving image; and
merge the image information into the area where the content does not change in real time.

12. The non-transitory computer-readable recording medium of claim 11,
wherein the image information includes at least one of per-pixel distance information about the moving image, drivable road information, or information about an object included in the moving image.

13. The non-transitory computer-readable recording medium of claim 12,
wherein the object information includes information related to an object detected as a polygonal window of a hexagon or an octagon, and
wherein four sides included in the polygonal window overlap four sides, respectively, included in one rectangle.

14. The non-transitory computer-readable recording medium of claim 11,
wherein the moving image includes a plurality of frames, and
wherein the one or more programs comprise instructions that, when executed by the processor, enable the processor to identify an area where a pixel value difference corresponding to at least two or more frames among the plurality of frames is within a set range and/or an area within a set distance as the area where the content does not change in real time.

15. The non-transitory computer-readable recording medium of claim 11, wherein the one or more programs comprise instructions that, when executed by the processor, enable the processor to:
identify a blank area with no pixel value in four corners of the moving image as the area where the content does not change in real time; and
identify the area where the content does not change in real time based on a set period.
